(19) United States
(12) Patent Application Publication
(10) Pub. No.: US 2017/0364642 A1
(43) Pub. Date: Dec. 21, 2017

(54) SYSTEMS, APPARATUS, ARTICLES, AND METHODS FOR IDENTIFYING LEVELS OF SERVICE IN A HOSPITAL DEPARTMENT

(71) Applicant: Texas Health Biomedical Advancement Center, Inc., Arlington, TX (US)

(72) Inventors: Sharon Renee Bogdanowicz, Haslet, TX (US); Kimberley Ann Shomette, Allen, TX (US)

(73) Assignee: Texas Health Biomedical Advancement Center, Inc., Arlington, TX (US)

(21) Appl. No.: 15/620,579

(22) Filed: Jun. 12, 2017

Related U.S. Application Data
(60) Provisional application No. 62/350,470, filed on Jun. 15, 2016.

(51) Int. Cl. G06F 19/00

(52) U.S. Cl. CPC G06F 19/327; G06F 19/322; G06F 19/328

(57) ABSTRACT

Provided are at least one system, apparatus, article, and method for providing an evaluation and management tool for identifying levels of service provided by a hospital department, such as the emergency department (ED). The at least one system, apparatus, article, and method may be applied for a patient visit to the hospital department, such as the ED, and for identifying the level of service associated with the visit.

### CROSS REFERENCE TO RELATED APPLICATIONS

This application claims priority to, and the benefit of, U.S. Provisional Application Ser. No. 62/350,470 entitled “SYSTEMS, APPARATUS, ARTICLES, AND METHODS FOR IDENTIFYING LEVELS OF SERVICE IN A HOSPITAL DEPARTMENT” filed on Jun. 15, 2016, the contents of which are hereby incorporated herein by reference in their entirety for any purpose.

### FIELD OF THE INVENTION

The invention describes novel systems, apparatus, and methods for providing or identifying levels of service associated with care of a patient in a hospital department, such as an emergency department.

### BACKGROUND

Care and/or treatment of a patient at a hospital department, such as an emergency department, requires utilization of many resources in the facility. Such care associated with a visit of a patient to that hospital department, such as the emergency room, is translated to a level of service. The level of service is then utilized to assess billing. Presently, how such resources (those utilized in the facility for the care and/or treatment of a patient at the hospital department, such as the emergency department) relate to the level of service are interpreted without proper standardization, because current practice often have the interpretation performed by persons who are not actually caring and/or treating the patient and/or are performed after the visit of the patient to the hospital, such as the emergency department. Many current practices do not allow real-time assignment of levels of service in accordance with a standardized system of practice. As such, the level of service associated with the visit of a patient to a hospital department, such as to the emergency room, when assessed may include large variances and discrepancies from visit to visit (e.g., by a same patient), and/or large variances and discrepancies have been found from patient to patient. The lack of adequate standards and/or consensus in the interpretation of cumulative services for a patient treatment and/or care associated with a visit at the hospital department, such as the emergency room, has also provided large variances in the billing for similar levels of service. There remains a need to overcome such variances, and to improve standardization, which includes providing improvements in the defining and/or assessing of levels of service in hospital departments, such as the emergency room.

### OVERVIEW

Provided are at least one system, apparatus, article, and method for providing an evaluation and management tool for identifying a levels of service provided by a hospital department, such as the emergency department (ED). The at least one system, apparatus, article, and method may be applied for a patient visit to the hospital department, such as the emergency department (ED), and for identifying the level of service associated with the visit, and for calculating facility charges associated with the visit.

In one or more embodiments are provided a system, article, apparatus, and method for calculating facility charges in a hospital department, such as an emergency department (ED).

In one or more embodiments are provided a system, article, apparatus, and/or method for providing an evaluation and management tool for levels of service provided by a hospital department, such as the ED, to a patient.

In one or more embodiments are provided a system, article, apparatus, and/or method that may be configured to operate within an existing electronic based system associated with the hospital department, such as the ED. In one or more embodiments, the system, article, apparatus, and/or method described herein may be configured and/or adapted to operate with and/or associate with an electronic health record (EHR), and associate with at least a portion of the computer readable program code associated with the electronic health record. In one or more embodiments, the system, article, apparatus, and/or method described herein includes computer readable program code and articles thereof that are associated with the EHR of a patient, the EHR of the patient being created, updated, and/or adapted when there is a visit by the patient to the hospital department, such as the ED.

In one or more embodiments are provided a system, article, apparatus, and/or method that define and/or described every resource associated with the treatment and/or care of the patient at the time the patient visits the hospital department, such as the ED, in the system, article, apparatus, and/or method, and in a manner that may be associated with the EHR of the patient.

In one or more embodiments are provided a system, article, apparatus, and/or method in which a resource associated with the treatment and/or care of the patient at the time of the visit of the patient to the hospital department, such as the ED, is associated with the EHR of the patient, and for every resource associated with the treatment and/or care of the patient a value is imposed. In one or more embodiments, the value is imposed for every resource. In one or more embodiments, the value is imposed for only certain resources. In one or more embodiments, the value is imposed based on a scale of values. In one or more embodiments, the value is imposed based on a single and fixed value. The value may be imposed at the time of the visit of the patient to the hospital department, such as the ED.

Through such a system, article, apparatus, and/or method, as described, and in which a resource is identified at the time of the visit of the patient utilizing the system, article, apparatus, and/or method, a level of service associated with the resource is provided for the visit of the patient to the hospital department, such as the ED. In one or more embodiments, the level of service may be provided at the time of the visit. In one or more embodiments, the level of service is provided by a resource value calculator as described herein. The level of service as provided herein (e.g., by the resource value calculator) may be provided as documentation. The level of service as provided herein (e.g., by the resource value calculator) may be provided to another department in the hospital.

The system, article, apparatus, and/or method, as described, provide a standardization for allocating resources associated with the treatment and/or care of the patient at the time of a visit of a patient to a hospital department, such as the ED.

The system, article, apparatus, and/or method, as described, provide a standardization for identifying level of service associated with the treatment and/or care of a patient associated with a visit of the patient to the hospital department, such as the ED.

The standardization is based on the allocating of resources associated with the treatment and/or care of the patient at the time of the visit of the patient to a hospital department, such as the ED utilizing a resource value calculator as described herein.

The standardization is maintained independent of the number of visits by a same patient, and/or by the number of visits by different patients, and/or by the number of same or different patients that visit that hospital department, such as the ED, regardless of whether the visit is on a same day, or on different days.

In one or more embodiments is a departmental management system for a health care department at a hospital. The departmental management system comprises at least a computer system including at least one computer, and at least one storage medium, accessible by the at least one computer, in which is stored at least all or a portion of a resource value calculator for generating an integer associated with care of a person by the health care department of the hospital in relation to a visit by the person to the health care department of the hospital. The departmental management system also comprises a request component within or in communication with the at least one computer. The departmental management system comprises a computer readable medium storing computer code which when executed by the computer system causes the computer system to perform operations. The operation may include to receive one or more requests associated with the care of the person by the health care department in relation to the visit of the person to the health care department. The operation may include to impose a value for each request based at least on information stored in the at least one storage medium. The operation may include to provide the integer based on the value imposed for each of the one or more requests, the integer determined in a calculation operation. With the system, the computer code may comprise code which when executed by the computer system causes the computer system to impose the value. With the system, the computer code may comprise code which when executed by the computer system causes the computer system to generate the integer. With the system, the integer may be associated with a level of service associated with the care of the person by the health care department in relation to the visit of the person to the health care department. With the system, the at least one storage medium may store or access at least a portion of health-related information of the person. With the system, the resource value calculator may be integrated with at least a portion of an electronic health record of the person. With the system, the at least one storage medium may include or access one or more databases, the one or more databases storing the value to be imposed for each request. With the system, the value to be imposed for each request may be associated with one or more departmental resources utilized in the request. With the system, the value to be imposed for each request may be associated with one or more departmental resources utilized in the request. With the system, the value to be imposed for each request may be associated with one or more departmental resources associated with the request, and the value is a numeric value less than 10, or less than 5, when the one or more resources are or are for non-critical care. With the system, the value to be imposed for each request may be associated with one or more departmental resources utilized with the request, and the value is a numeric value less than 10, or less than 5, when the one or more resources are or are for non-critical care. With the system, the value to be imposed may be greater than 10, or greater than 50, or greater than 100, when the one or more resources is for critical care.

In one or more embodiments is a method of management for a health care department of a hospital using a computer system including at least one computer, at least one storage medium, accessible by the at least one computer, in which is stored all or at least a portion of a resource value calculator, and a request component within or in communication with the at least one computer. The method comprises receiving, by the computer system, one or more requests associated with a visit by the person to the health care department of the hospital. The method comprises imposing a value for at least some of the requests based on one or more resources associated with the at least some of the requests, in which for at least some of the requests the value imposed is associated with the one or more resources associated with the request, the value being stored in the at least one storage medium accessible by the at least one computer. The method comprises providing an integer based on the value imposed for the at least some of the requests, the integer being determined in a calculation operation. The method may comprise, generating, by the computer system, a level of service for the visit by the person to the health care department of the hospital. The method may comprise generating, by the computer system, a level of service for the visit by the person to the health care department of the hospital, the level of service being stored in at least one database. The method may comprise transmitting the level of service.

In one or more embodiments is a non-transitory computer readable storage medium in which is stored computer code that causes a computer system to perform a method, the computer system comprising at least one computer, at least one storage medium, accessible by the at least one computer, in which is stored a value resource calculator, the computer code to perform the method. The method comprises receiving, by the computer system, one or more requests associated with a visit by the person to the health care department of the hospital. The method comprises imposing a value for at least some of the requests based on one or more resources associated with the at least some of the requests, in which for at least some of the requests the value imposed is associated with the one or more resources associated with the request, the value being stored in the at least one storage medium accessible by the at least one computer. The method comprises providing an integer based on the value imposed for the at least some of the requests, the integer being determined in a calculation operation. With the non-transitory computer readable storage medium the method may comprise generating, by the computer system, a level of service for the visit. With the non-transitory computer readable storage medium, the method may comprise generating, by the computer system, a level of service for the visit stored in the at least one storage medium.

In one or more embodiments is a management system for a health care department of a hospital, the management system comprising at least one controller that controls transmission of a plurality of requests, each request for at least one resource associated with a visit of a person at the health care department, captured by at least one computing device at the health care department of a hospital. The management system further comprises a processing system that determines authorization for the plurality of requests or determines authorization to access the at least one computing device. The management system further comprises a value engine that interfaces between the at least one controller and the processing system, wherein the at least one controller receives the plurality of requests captured by the at least one computing device, and the value engine is configured to access at least some of the plurality of requests, or to intercept at least some of the plurality of requests before the plurality of requests are received by another processing system, wherein the value engine in response to accessing or intercepting the plurality of requests performs a computer implemented method of imposing a value associated with the plurality of requests. The method comprises accessing or intercepting at least some of the plurality of requests by the at least one controller. The method comprises determining a value associated with each request, which includes determining whether there is at least one value associated with each request, and imposing a value for each request that is determined to correlate with at least one value. The method comprises imposing the value that is associated with each request, or for each request that is determined to correlate at least one value, thereby imposing a plurality of values. In a calculation operation, and in response to imposing the plurality of values, the method comprises determining an integer associated with the plurality of values. With the management system, the method may further comprise transmitting the integer to another computing device in the system to determine a level of service associated with the integer, the level of service identified from a relational table correlating each integer with one level of service, the level of service comprising Levels 1 to 5 and Critical Care.

These and other embodiments are described further below.

### BRIEF DESCRIPTION OF DRAWINGS

Embodiments are illustrated by way of example in the accompanying figures not necessarily drawn to scale, in which like numbers indicate similar parts, and in which:

FIGS. 1-58 depict representative embodiments and/or means for imposing a value associated with a selection of one or more resources as described herein.

FIG. 59 depicts representative pathways for when a value is imposed, and/or representative steps utilized to trigger a value to be imposed, as described herein.

FIG. 60 illustrates representative values imposed for resources as described herein.

FIGS. 61 and 62 each illustrate representative levels of service when values are imposed and applied through a resource value calculator as described herein.

### DETAILED DESCRIPTION

Although making and using various embodiments are discussed in detail below, it should be appreciated that as described herein are provided many inventive concepts that may be embodied in a wide variety of contexts. Embodiments discussed herein are merely representative and do not limit the scope of the invention.

Systems, apparatuses, and methods, for allocating resources, and/or generating a level of service in a hospital department are provided. The level of service may be associated with at least one resource allocated to a patient for a visit by the patient to the hospital department. The level of service may be associated with more than one resource. The level of service may be associated with processing a plurality of resources associated with a patient when the patient has a visit to the hospital department. In one or more embodiments, the level of service may be associated with one or more resources selected and/or utilized by one or more facilitators associated with care of the patient in the hospital department, such as the ED. The one or more facilitators may include any one or more of an administrator, a medical technician, a nurse, a doctor, as examples, or any suitable facilitator involved with the care of the patient for the visit of the patient to the hospital department, such as the ED. The one or more resources may include tools, articles, medicines, and/or other resources utilized by one or more facilitators for the care of the patient in the hospital department, such as the ED. In one or more embodiments, the one or more resources may be allocated in one or more categories. Taking the ED as an example, the categories may include, as examples, initial intake, diagnostics, medication administration, interventions (e.g., LDA, cardiopulmonary), general procedures, specific procedures (e.g., orthopaedic-related, psychological/social/safety-related), pregnancy-related, acute/stat procedures (e.g., STEMI, stroke-related, critical care-related), and disposition. The category may also include filing and/or a facilities modifier.

Generally, the level of service, and the generating of the level of service with one or more resources as described herein, is triggered by a visit of a patent to the hospital department, such as the ED. In one or more embodiments, the level of service is accompanied by a code and or internal identifier, which may be utilized for other purposes, such as, but not limited to, billing.

Examples of levels of service for a department, such as the ED, include the following:
Level 1 (code A)—Often, one or more presenting problems are self-limited or minor. Generally, no additional departmental resources are utilized. An example includes when a patient is fast tracked outside of an ED bed, such as when the patient is examined by a physician but is not placed in ED bed, and is discharged from a waiting room.
Level 2 (code B)—Often, one or more presenting problems are of low to moderate severity. Generally, a simple procedure can be performed with minimal departmental resources. Examples include: (a) laceration repair; (b) medication refills; (c) headache pre-existing.
Level 3 (code C)—Often, one or more presenting problems are of moderate severity. Generally, one or more moderate departmental resources are utilized to treat and/or diagnose the patient. Examples include: (a) arm injury rule out fracture; (b) cough; (c) pharyngitis; (d) uterine tract infection; (e) back pain; (f) fever.
Level 4 (code D)—Often, one or more presenting problems are of high severity, and require urgent evaluation by the physician, or one or more qualified health care professionals, but do not pose an immediate significant threat to life or physiologic function. Generally, one or more or significant resources are utilized to treat and/or diagnose the patient; may include admission to the hospital. Examples include: (a) male abdominal pain requiring significant departmental resources, and may include admission; (b) chest pain requiring significant departmental resources, and may include admission; (c) fever requiring significant departmental resources; (d) female abdominal pain, discharged home.
Level 5 (code E)—Often, one or more presenting problems are of high severity, and pose an immediate significant threat to life or physiologic function. Generally, this requires extensive departmental resources, and often the patient will require admission to the hospital. Examples include: (a) chest pain requiring extensive departmental resources, and may include admission for many patients; (b) abdominal pain requiring extensive departmental resources, and may include admission for many patients; (c) Suicidal patient, may include transfer of patient to another (e.g., more suitable) facility; (d) COPD exacerbation requiring extensive departmental resources and may include admission for many patients.
Critical Care (code E)—For critical care, evaluation and/or management of a critically ill and/or critically injured patient, generally performed in the first 30-74 minutes. Generally, this includes patients having life threatening illnesses/symptoms/injuries that require 1:1 nursing, and/or ancillary care. Generally, this requires utilizing the most extensive departmental resources. Examples include: (a) pulmonary embolism; (b) respiratory failure; (c) multi-system trauma; (d) ST elevated myocardial infarction; (e) cerebral vascular accident (CVA); (f) Status asthmaticus; (g) diabetic ketoacidosis; (h) altered mental status.

In one or more embodiments, each resource is selected in a system, article, apparatus, and/or method described herein, and is in accordance with a visit of the patent to the hospital department, such as the ED.

The systems, articles, and/or methods described herein are associated with at least one apparatus. The at least one apparatus described herein will include one or more non-transitory computer-readable media. The non-transitory computer-readable media may store one or more computer-executable instructions. The computer-executable instructions, when executed by a controller or processor of an article, and/or apparatus, such as a computing device and/or server, may perform a method described herein, such as determining or generating a level of service associated with a visit of the patent to the hospital department, using ED as the example. The method may comprise or may further comprise selecting from a plurality of resources, each selected resource associated with the visit of the patent to the ED. In one or more embodiments, the visit of the patient to the ED is a same visit. In one or more embodiments, the visit of the patient to the ED is one visit. The method may comprise or may further comprise providing and/or imposing a value for at least some or all of the resources associated with the visit of the patent to the ED. The providing and/or imposing a value for at least some or all of the resources may be based on selection of the resource and/or on selection of the type and/or quality and/or quantity of the resource and/or selection of at least one resource. The providing and/or imposing a value for at least some or all of the resources may be based on selection of one resource, or at least one resource, from a plurality of resources. At least some or all of the selected resources may be associated with one or more values. At least some or all of the selected resources may be associated with one or more instructions for imposing a value, or for imposing one value (e.g., from a plurality of values). At least some or all of the selected resources may correspond with and/or correlate with a record. The selecting of at least one resource, and the imposing a value for least at some or all of the selected resources may cause the computing device to record, and/or process, and/or further process, the at least one selected resource. The selecting of at least one resource, and the imposing a value for least at some or all of the selected resources may cause the computing device to record, and/or process, and/or further process, the imposed value for the selected resources for which the value is imposed.

The at least one apparatus described herein may include a computer readable program code embodied in computer readable media associated with at least one processor of the at least one apparatus, such as the computing device or server. In one or more embodiments, at least a portion of the computer readable program code may be embodied in the at least one apparatus. In one or more embodiments, all or at least a portion of the computer readable program code is accessible and/or in communication with the processor of the at least one apparatus. In one or more embodiments, all or at least a portion of the computer readable program code is controlled by the at least one processor of the at least one apparatus. The at least one processor and/or a controller is configured to execute all or at least a portion of the computer readable program code, which causes the at least one apparatus (e.g., computing device, server, and/or controller) to perform one or more tasks. The computer readable program code (all or a portion of which may be embodied with the processor of the at least one apparatus) may cause the at least one apparatus to receive the selection of resources from the plurality of resources. The computer readable program code (all or a portion of which may be embodied by the processor of the at least one apparatus) may cause the at least one apparatus to record the selection of resources, or record at least one, or record at least a portion of the selection of resources. The computer readable program code (all or a portion of which may be embodied by the processor of the at least one apparatus) may cause the at least one apparatus to provide such one or more records as output. The computer readable program code (all or a portion of which may be embodied by the processor of at least one apparatus) may cause the at least one apparatus to identify violations in the selection of resources from the plurality of resources, which may be accompanied by transmission of output and/or a directive notifying of the violation.

The computer readable program code (all or a portion of which may be embodied by the processor of at least one apparatus) may cause the at least one apparatus to impose a value for only the selected resources for which the value is imposed. The computer readable program code (all or a portion of which may be embodied by the processor of at least one apparatus) may cause the at least one apparatus to impose a value for each selected resource. The computer readable program code may be a resource value calculator, as further described herein.

In one or more embodiments, the imposed value for the selected resource is predetermined. In one or more embodiments, the imposed value for the selected resource is subject to change. In one or more embodiments, the imposed value for the selected resource is consistent in the articles, apparatus, systems, and/or methods described herein, even in different geographic regions.

Any change in a value may correspond with a change in the level of service.

In one or more embodiments, the articles, apparatus, systems, and/or methods described herein may only be accessed by an authorized user.

In one or more embodiments, the articles, apparatus, systems, and/or methods described herein do not allow the articles, apparatus, systems, and/or methods to alter the value imposed for the selected resource once the articles, apparatus, systems, and/or methods are implemented. In one or more embodiments, the articles, apparatus, systems, and/or methods described herein do not allow the articles, apparatus, systems, and/or methods to alter the value imposed for the selected resource, once the value has been imposed. In one or more embodiments, the articles, apparatus, systems, and/or methods described herein do not allow the articles, apparatus, systems, and/or methods to alter the value imposed for the selected resource unless there is a rule to alter the value. In one or more embodiments, the rule utilized to alter the value is only implemented by an authorized user. In one or more embodiments, articles, apparatus, systems, and/or methods described herein allow the system, apparatus, and/or method to later alter the value imposed for each resource, based on an adjustment, such as determined by data collected (e.g., about the resource).

The at least one apparatus described herein may include an article, such as an article of manufacture, the article comprising a non-transitory computer usable medium, which may include all or at least a portion of a computer readable program code embodied therein. The computer readable program code when executed by the controller or the processor of the at least one apparatus and/or article may generate one or more directives.

The computer readable program code as described herein (all or a portion of which may be embodied by the at least one apparatus and/or article) may cause at least one apparatus to generate a directive. The directive may be associated with a selected resource, and/or the selection of the resource. The directive may be associated with navigation in relation to the computer readable program code. The directive may be associated with a level of service caused by the computer readable program code. The directive may include a request. The directive may include one or more instructions. The directive may include or may be associated with output. The directive may include a further transaction and/or communication, such as to another apparatus and/or article in or associated with the computer readable program code. The directive may be associated with a rule. The rule may be associated any one or more of the resource, and/or the selection of the resource, the value, the navigation, the level of service, and/or any one or more record and/or output. The computer readable program code (all or a portion of which may be embodied by the at least one apparatus and/or article) may cause the at least one apparatus and/or article to record the directive. The computer readable program code (all or a portion of which may be embodied by the at least one apparatus and/or article) may cause the at least one apparatus and/or article to display the directive. The computer readable program code (all or a portion of which may be embodied by the at least one apparatus and/or article) may cause the at least one apparatus and/or article to transmit the directive. The computer readable program code (all or a portion of which may be embodied by the at least one apparatus and/or article) may cause the at least one apparatus and/or article to provide the directive as output.

The computer readable program code (all or a portion of which may be embodied by the at least one apparatus and/or article) may cause the at least one apparatus and/or article to generate and/or determine a level of service. The computer readable program code (all or a portion of which may be embodied by the at least one apparatus and/or article) may cause the at least one apparatus and/or article to record the level of service. The computer readable program code (all or a portion of which may be embodied by the at least one apparatus and/or article) may cause the at least one apparatus and/or article to transmit the level of service, such as to another apparatus and/or article. The computer readable program code (all or a portion of which may be embodied by the at least one apparatus and/or article) may cause the at least one apparatus and/or article to provide the level of service as output. The computer readable program code (all or a portion of which may be embodied by the processor of the computing device) may cause the computing device and/or the controller to communicate the level of service to a computing device in or associated with the computer readable program code.

The at least one apparatus and/or article described herein may include, or may be in communication with and/or may access the resource value calculator as described herein. In one or more embodiments, the resource value calculator may include a non-transitory computer usable medium, in which the non-transitory computer usable medium includes at least one computer readable program code embodied therein. The resource value calculator may include at least one processor configured to execute all or at least a portion of the at least one computer readable program code of the resource value calculator. The resource value calculator may be utilized to calculate at least a level of service. The level of service is derived from and/or generated from input comprising at least the selection of one or more resources, and/or the metrics described herein associated with the selection of resources, the input associated with the visit of the patent to the hospital department, such as the ED. In one or more embodiments, the level of service is derived from and/or generated from input comprising at least the selection of a resource associated with the visit of the patent to the ED. In one or more embodiments, the level of service is derived from and/or generated from input comprising at least the selection of a resource associated with one or more categories having one or more resources therein, each category associated with the ED. The computer readable program code of the resource value calculator may be utilized to cause the resource value calculator to impose the value associated with selection of the one or more resources associated with the visit of the patient to the ED. The computer readable program code of the resource value calculator may be utilized to cause the resource value calculator to impose the value associated with selection of the one or more resources from one or more categories, each category associated with the visit of the patient to the ED. The value may be imposed for one, or for a plurality of selected resources. The selection of a resource may impose a fixed value. The fixed value may be pre-determined. The value may be a numeric value. The value may be a numeric value, provided and/or pre-determined from a range of numeric values, in which each value is a number value from 1 to 200. In one or more embodiments, the value is a numeric value and will be, when imposed, less than 10 for every resource that is not critical care. In one or more embodiments, the value is a numeric value and is between 1 and 10, or is between 1 and 5, for any resource that is not critical care. In one or more embodiments, only a resource for critical care imposes a value greater than 10, or greater than 50, or greater than 100. In addition, or as an alternative, selection of a resource may impose a value from a selection (set) of values, which may be based on type of resource, quality of the resource, quantity of the resource, and/or cost of the resource, as examples. The set of values may be pre-determined. In one or more embodiments, the computer readable program code of the resource value calculator may cause the resource value calculator to correlate a second value to the imposed value.

In one or more embodiments, the resource value calculator may calculate the level of service by an adjustment associated with the one or more values imposed, and based on the visit of the patient to the ED. In one or more embodiments, the adjustment is associated with at least one range, in which the range is derived from a plurality of values imposed by the resource value calculator. The adjustment may be based on a value in the at least one range.

In one or more embodiments, the resource value calculator may calculate the level of service based on a change in the resource and/or a change in the one or more values imposed. In one or more embodiments, the resource may be associated with a resource degree, and/or may be based on the degree, and/or on data collected about the resource or the resource degree, and the resource may be changed, or may be associated with a change. The resource degree and/or data collected may include, for example, the quantity of the resource, the quality of the resource, the timing of the resource, the cost of the resource, as representative examples.

In one or more embodiments, selection of a first resource may cause the resource value calculator to impose a first value. In one or more embodiments, selection of a first resource may cause the resource value calculator to impose only one first value, such that the first value is always associated with the first resource. In one or more embodiments, selection of at least one resource (e.g., a first resource) may cause the resource value calculator to impose a next value (e.g., a second value).

In one or more embodiments, selection of a first value for at least one resource (e.g., a first resource) may cause the resource value calculator to impose a next (e.g., a second value). The next (or second value) may be associated with a second resource that is associated with the at least one first resource.

In one or more embodiments, selection of a first resource may be followed by selection of a second resource, and the selection of the second resource may cause the resource value calculator to impose a second value. In one or more embodiments, selection of the second resource always imposes the second value, in that the second value is always associated with the second resource.

In one or more embodiments, a computer readable program may cause the computing device and/or controller to impose a first value with one or a plurality of first resources.

In one or more embodiments, a computer readable program may cause the computing device and/or controller to impose a second value with one or a plurality of second resources.

In one or more embodiments, the first value is a fixed value. In one or more embodiments, the second value is a fixed value.

The at least one apparatus and/or article described herein may include, or may be in communication with, and/or may access the non-transitory computer usable medium having the computer readable program code and resource value calculator, and when executed by a processor of a computing device and/or controller (e.g., apparatus and/or article described herein), may determine the one or more resources that may impose a value. The computer readable program code may cause the resource value calculator to impose a value only with certain resources. The computer readable program code may cause the resource value calculator to correlate at least one value with only certain resources. In one or more embodiments, the computer readable program code may cause the resource value calculator to impose a plurality of values based only on selection of a plurality of resources in which some or all of the plurality of resources each correlate with at least one value.

In one or more embodiments, the computer readable program code may cause the resource value calculator to determine the value to impose. The computer readable program code may cause the resource value calculator to correlate a first value with a second value. In one or more embodiments, the second value may be less than the first value. In one or more embodiments, the second value may be the same as the first value. In one or more embodiments, the second value may be greater than the first value. In one or more embodiments, the computer readable program code may cause the resource value calculator to impose the greater value.

In one or more embodiments, the computer readable program code may cause the resource value calculator to impose a change in value. The change in value may be based on data collected about the resource or a resource degree, or based on a user input. In one or more embodiments, the computer readable program code may cause the resource value calculator to determine a different value. In one or more embodiments, the computer readable program code may cause the resource value calculator to determine a different value based on a selection and/or correlation of the selected resource with another resource. In one or more embodiments, the computer readable program code may cause the resource value calculator to determine between at least a first value and a second value. In one or more embodiments, the first value and the second value are the same, and only one of the first or the second value is imposed. In one or more embodiments, the first value and the second value are different, and only one of the first or the second value is imposed. In one or more embodiments, the greater value is imposed.

In one or more embodiments, the one or more resources may be displayed in real-time with the articles, apparatus, systems, and/or methods described herein. In one or more embodiments, any of the resources displayed with the articles, apparatus, systems, and/or methods described herein may be displayed simultaneously, and/or in series.

In one or more embodiments, any of the resources may be selected and/or identified in real-time with the articles, apparatus, systems, and/or methods described herein. In one or more embodiments, any of the resources selected and/or identified with the articles, apparatus, systems, and/or methods described herein may be selected and/or identified simultaneously, and/or in series.

In one or more embodiments, any of the resources selected may be processed in real-time with the articles, apparatus, systems, and/or methods described herein. In one or more embodiments, any of the resources processed with the articles, apparatus, systems, and/or methods described herein may be processed simultaneously, and/or in series.

In one or more embodiments, any of the resources selected with the articles, apparatus, systems, and/or methods described herein may be provided in at least one record, and/or in a plurality of records. In one or more embodiments, any of the resources recorded with the articles, apparatus, systems, and/or methods described herein may be recorded simultaneously, and/or in series. In one or more embodiments, any of the resources selected may be provided in a database, and/or may be extracted from a database, including a database comprising historical records.

In one or more embodiments, one or a plurality of first resources are associated with a first value.

In one or more embodiments, one or a plurality of second resources are associated with a second value.

In one or more embodiments, one or a plurality of first resources are associated with at least one category, in which the category represents a type or family of activities utilizing one or a plurality of resources in the hospital department, such as the ED. In one or more embodiments, at least one resource is selected from a plurality of categories associated with the visit to the ED, in which the categories include, but are not limited to: (i) initial patient intake for the visit to the ED; (ii) patient diagnostics during the visit to the ED; (iii) medications provided to the patient during the visit to the ED; (iv) interventions (e.g., LDA, cardiopulmonary) provided to the patient during the visit to the ED; (v) general procedures provided to the patient during the visit to the ED; (vi) specific procedures provided to the patient (e.g., orthopaedic-related, psychological/social/safety-related, pregnancy-related) during the visit to the ED; (vii) acute/stat procedures provided to the patient (e.g., STEMI, stroke-related, critical care-related) during the visit to the ED; and (vii) disposition of the patient at the end of the visit to the ED. Some or all of the plurality of categories may be represented, and/or may be utilized by the resource value calculator.

In one or more embodiments, the resource value calculator may cause the at least one apparatus and/or article (which may be and/or may comprise at least one processor and/or controller) to impose a first value when one of the plurality of first resources are selected, the one of the plurality of first resources correlated to and/or associated with the first value.

In one or more embodiments, the resource value calculator may cause the at least one apparatus and/or article (which may be and/or may comprise at least one processor and/or controller) to impose a second value when one of the plurality of second resources are selected, the one of the plurality of second resources correlated to and/or associated with the second value.

In one or more embodiments, the resource value calculator may cause the at least one apparatus and/or article (which may be and/or may comprise at least one processor and/or controller) to calculate an adjustment. The adjustment may be based on the first value imposed. The adjustment may be based on a plurality of first values imposed. The adjustment based on the second value imposed. The adjustment may be based on a plurality of second values imposed. The adjustment may be based on a plurality of values imposed, the values being first, second, and/or other values imposed and based upon selection of first, second, and/or other resources, respectively, that correlate to and/or associate with such first, second, and/or other values. In one or more embodiments, the resource value calculator may cause the at least one apparatus and/or article (which may be and/or may comprise at least one processor and/or controller) to calculate an adjustment based on all values imposed in at least one category of resources associated with the visit of the patient to the hospital department, such as the ED, in which resources in the at least one category of resources include those resources that correlate to and/or are associated with a value. In one or more embodiments, the resource value calculator may cause the at least one apparatus and/or article (which may be and/or may comprise at least one processor and/or controller) to calculate an adjustment based on all values imposed for all resources associated with the visit of the patient to the hospital department, such as the ED, in which the resources associated with the visit of the patient to the ED are that that correlate to and/or are associated with a value.

Embodiments may further comprise one or more non-transitory computer readable media storing computer executable instructions that, when executed by a processor of at least one apparatus and/or article (which may be and/or may comprise at least one processor and/or controller), perform at least one method for providing a value associated with a resource for a visit of the patent to the hospital department, such as the ED. The method may include receiving a request for the resource. The method may include identifying the resource from a plurality of resources. The method may include identifying one or more items associated with the resource. The resource and/or the one or more items (associated with the resource) may be associated with a value. Each resource and/or the one or more items (associated with the resource) may be associated with its own value. The value may be a fixed value. The value may be a fixed numeric value. The fixed value may be changed based on type, quantity, quality, and/or cost of the resource and/or the one or more items associated with the resource. Not all resources may be associated with a value. The resource and/or the one or more items may be associated with one or more values. The value may be based on type, quantity, quality, and/or cost of the resource and/or the one or more items associated with the resource. The method may include identifying a resource in a category, in which there may be a plurality of categories and a plurality of resources in each category. The method may include determining the value based on the resource, and/or the one or more items associated with the resource, and/or the category. The method may include determining only one value based on the resource, and/or the one or more items associated with the resource, and/or the category. The method may include determining only one value that is a highest value, based on the resource, and/or the one or more items associated with the resource, and/or the category. The method may include receiving a request for a second resource. The second resource may be the same or may differ from the previous resource. The second resource may be associated with one or more items. The second resource and/or the one or more items (associated with the second resource) may be associated with a second fixed value and/or a selection of second fixed values. The second fixed value and/or a selection of second fixed values may be the same or different from the previous fixed values (or selection thereof). The method may include determining a second value based on the second resource, and/or the one or more items (associated with the second resource), and/or a second category. The method may include determining only one second value based on the second resource, and/or the one or more items (associated with the second resource), and/or the second category. The method may include determining only one second value that is a highest second value, based on the second resource, and/or the one or more items (associated with the second resource), and/or the second category. The method may include determining only one value for each resource based on a resource degree, and/or based on data collected about the resource (or resource degree). The method may include upon determining the value, identifying all the values for the patient associated with the visit to the hospital department, such as the ED. The method may include upon identifying all the values for the patient associated with the visit to the ED, generating an adjustment value based on all the value identified. The adjustment value generated may be based on a final value calculated after all the values are determined after receiving all the requests for all the resources and/or after identifying all the resources for the patient associated with the visit to the ED. The method may include in response to generating the adjustment value, generating a level or service.

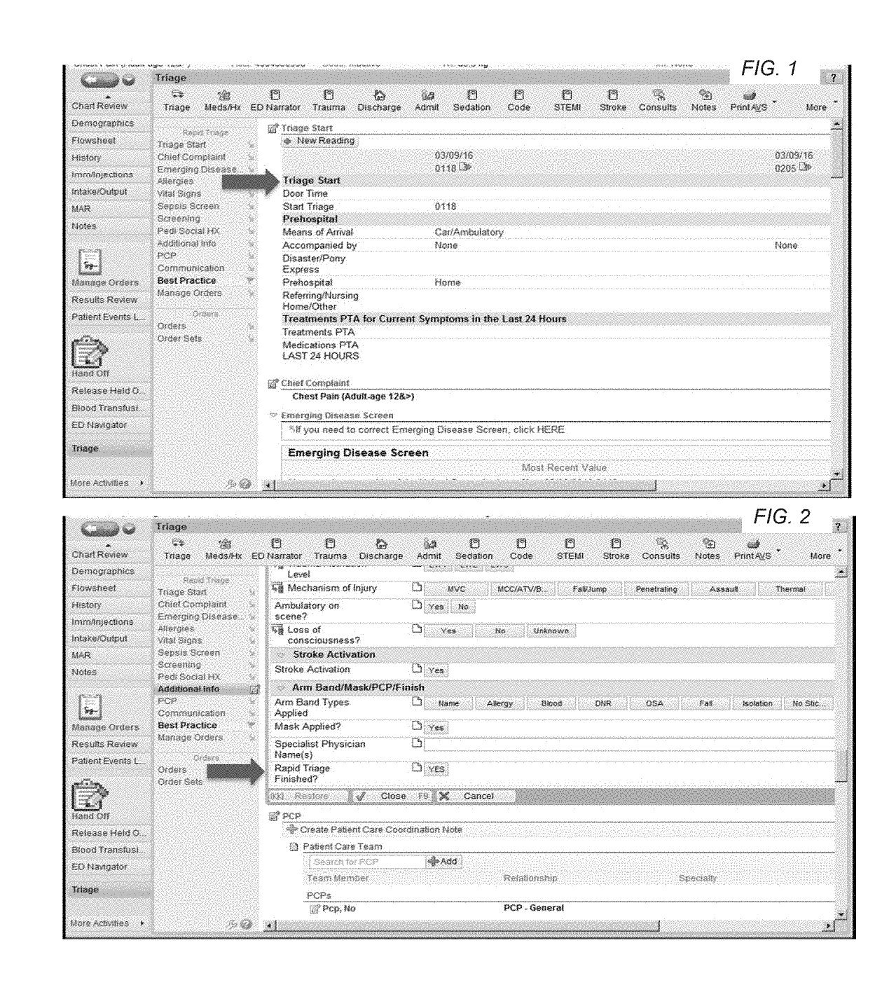

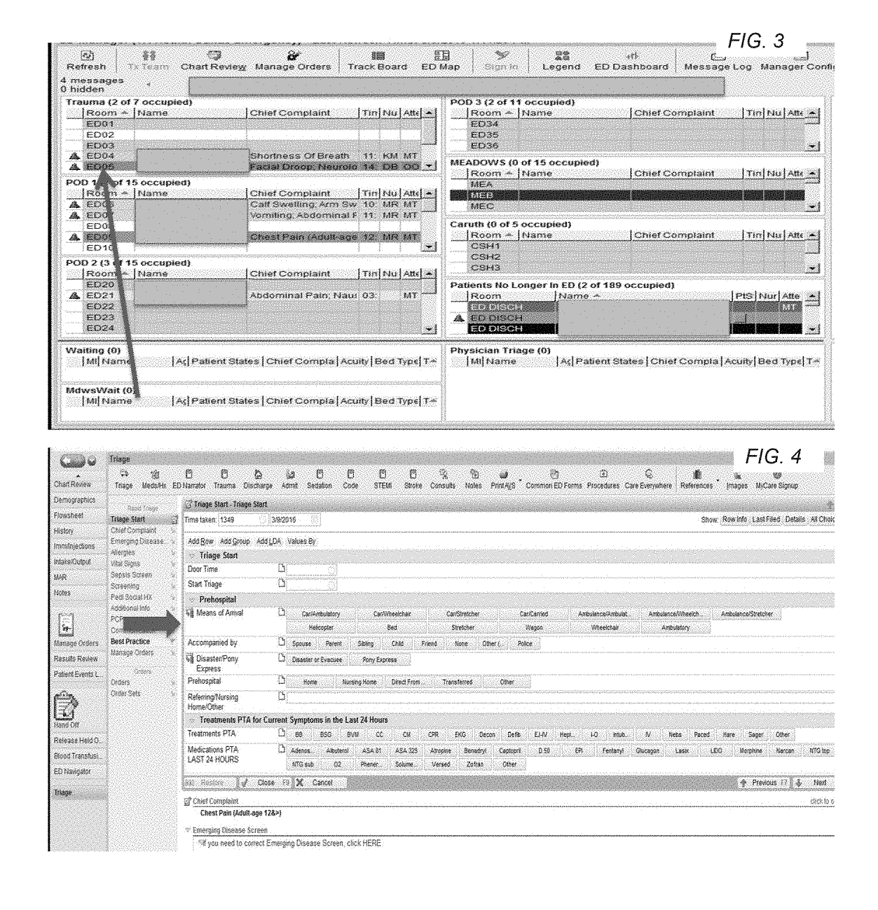

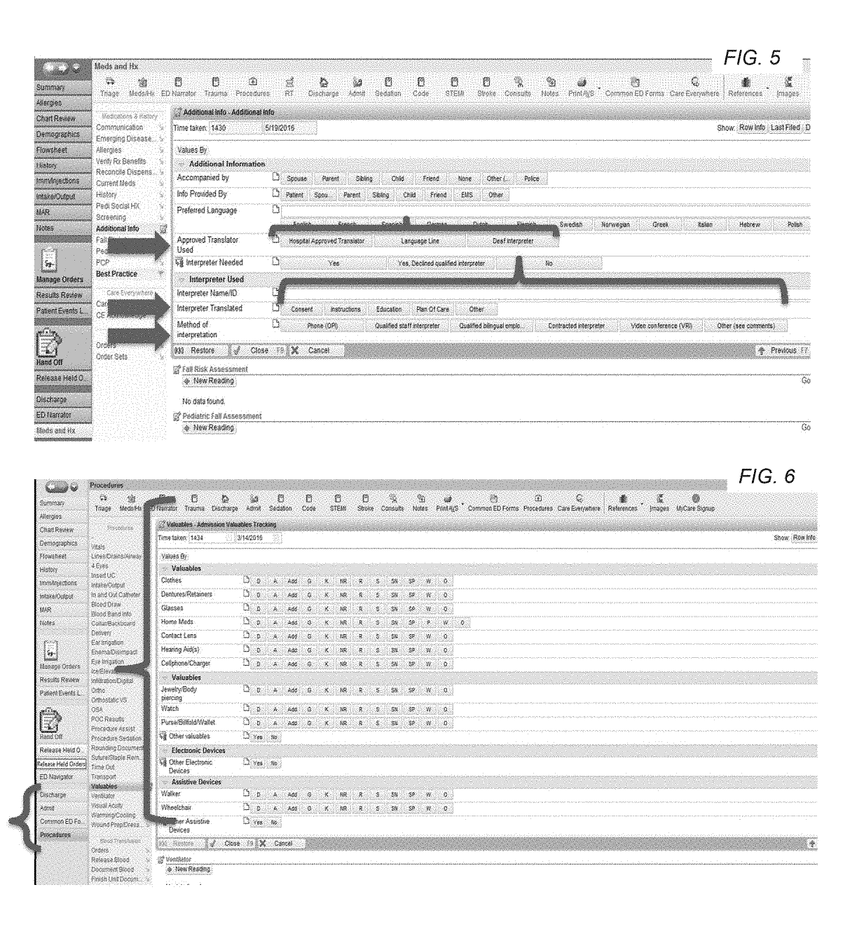

Utilizing the ED, a first representative category of resources available with the systems, apparatuses, articles, and methods described herein for a visit of a patient to the ED is depicted in TABLE 1, which is representative of patient intake resources; the table provides such representative resources and their general description, the resources in TABLE 1 being those for which a value is imposed as described herein. For example, with triage, its value may be imposed when rapid triage is finished after it is initially selected (e.g., selection of rapid triage in an electronic system or computer readable program code, which may be, or may be associated with, the system, apparatus, article, and/or method described herein) as depicted in FIGS. 1 and 2 (and/or arrow(s) in the figures). With room, its value may be imposed when a patient is moved from a waiting room into an ED room, or when a patient arrives via ambulance (e.g., selection of a room in an electronic system or computer readable program code, which may be, or may be associated with, the system, apparatus, article, and/or method described herein) as depicted in FIG. 3 (and/or arrow(s) in the figure). With means of arrival, its value may be imposed when a patient arrives via ambulance or utilized a resource outlined in TABLE 1 (e.g., selection of such a resource in an electronic system or computer readable program code, which may be, or may be associated with, the system, apparatus, article, and/or method described herein) as depicted in FIG. 4 (and/or arrow(s) in the figure). With language/communication, its value may be imposed when a translator or method of interpretation is approved and/or utilized as outlined in TABLE 1 (e.g., selection of such a resource in an electronic system or computer readable program code, which may be, or may be associated with, the system, apparatus, article, and/or method described herein) as depicted in FIG. 5 (and/or arrow(s) in the figure). With valuables, its value may be imposed with admission, discharge, or use of common/appropriate forms or procedures (e.g., selection of such a resource in an electronic system or computer readable program code, which may be, or may be associated with, the system, apparatus, article, and/or method described herein) as depicted in FIG. 6 (and/or arrow(s) in the figure).

TABLE 1

| | |
|---|---|
| Triage | Includes triage of the patient to determine proper room |
| | placement and urgency to be seen. |
| Room | Includes use of ED room. |
| Means of | Includes resources used for patients that come in via |
| arrival | EMS, room set up, transferring of patient onto ED |
| | gurney, applying monitoring devices, etc., as well as |
| | ALS/BLS arrivals. |
| Language/ | Includes additional specialized communication and/or |
| Communication | cognitive facility resources and/or interpreter, such as |
| | when the patient and care giver do not speak the same |
| | language, or when a patient is mute and/or deaf. |
| Valuables/ | Includes documentation of patients' clothing and/or |
| Documentation | valuables, and/or securing valuables in hospital safe. |
| of valuables | |

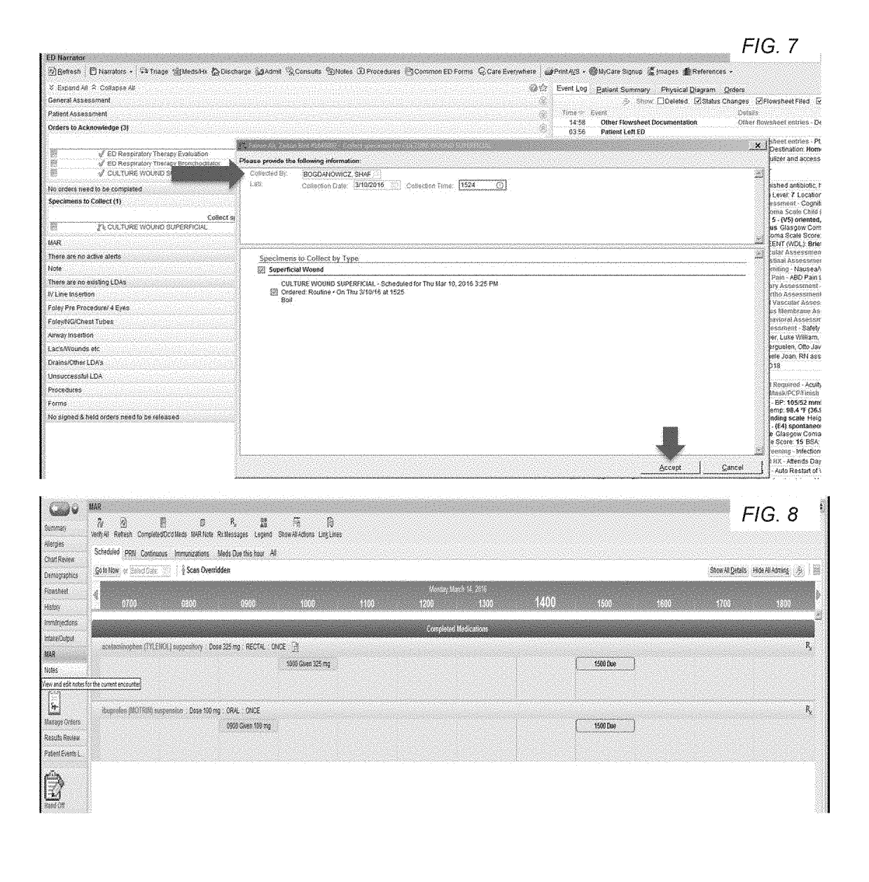

Another representative category of resources available with the systems, apparatuses, articles, and methods described herein for a visit of a patient to the ED is depicted in TABLE 2, which is representative of patient diagnostics during the visit to the ED; the table provides such representative resources and their general description, the resources in TABLE 2 being those for which a value is imposed as described herein. For example, with lab, or radiology, or EKG, its value may be imposed when the request (order) is made (e.g., selection of such a resource in an electronic system or computer readable program code, which may be, or may be associated with, the system, apparatus, article, and/or method described herein). With MRI/CT/US/NM, its value may be imposed when a physician order is entered (e.g., selection of such a resource in an electronic system or computer readable program code, which may be, or may be associated with, the system, apparatus, article, and/or method described herein). With specimen collection, its value may be imposed when the request or order is made (e.g., selection of such a resource in an electronic system or computer readable program code, which may be, or may be associated with, the system, apparatus, article, and/or method described herein) as depicted in FIG. 7 (and/or arrow(s) in the figure).

TABLE 2

| | |
|---|---|
| Lab | Includes ordering and/or scheduling of laboratory tests, |
| | monitoring test results, and reporting laboratory results |
| | to the physician. |
| Radiology | Plain films, x-rays; includes ordering and/or scheduling |
| | radiology procedures, monitoring results, reporting to |
| | physician and discrepancy monitoring, and/or call back |
| | as needed. |
| EKG | Includes processing EKG order, monitoring results, |
| | reporting to physician, and/or discrepancy monitoring. |
| MRI/CT/ | Includes ordering and/or scheduling radiology and/or |
| US/NM | ultrasound procedures, monitoring results, reporting to |
| | physician, and/or discrepancy monitoring, and/or call |
| | back as needed. |
| Specimen | Includes collection of one or more of: urine, cerebral |
| collection | spinal fluid, stool, wound, nasal, and/or throat specimens |
| | for the purpose of diagnostic testing; documentation of |
| | nurse/technician collection is typically required. |

Still another representative category of resources available with the systems, apparatuses, articles, and methods described herein for a visit of a patient to the ED is depicted in TABLE 3, which is representative of medications provided to the patient during the visit to the ED; the table provides such representative resources and their general description, the resources in TABLE 3 being those for which a value is imposed as described herein. For example, with SL/Oral, and/or topical/transdermal/optic/rectal/otic, the value may be imposed with completion of administration of the medication via a medication administration record (MAR) or an electronic MAR (eMAR) (e.g., completion in an electronic system or computer readable program code, which may be, or may be associated, with the system, apparatus, article, and/or method described herein) as depicted in FIG. 8.

TABLE 3

| | |
|---|---|
| SL/Oral | Includes procurement and administration of oral and/or |
| | sub-lingual medications, administration to patient, |
| | assessment, and monitoring/reporting patient response |
| | to medication. |
| Topical/ | Includes procurement and administration of topical, |
| Transdermal/ | transdermal, otic, rectal, and optic medications, |
| Otic/Rectal/ | administration to patient, assessment and monitoring/ |
| Optic | reporting patient's response to medication. |

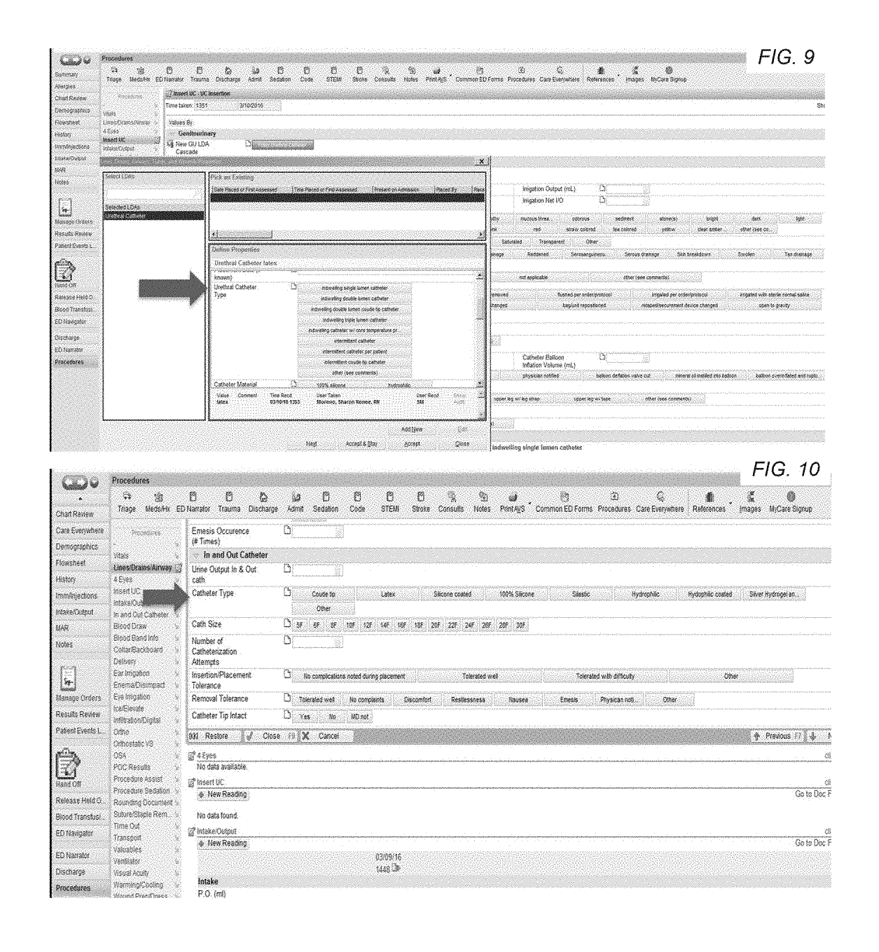

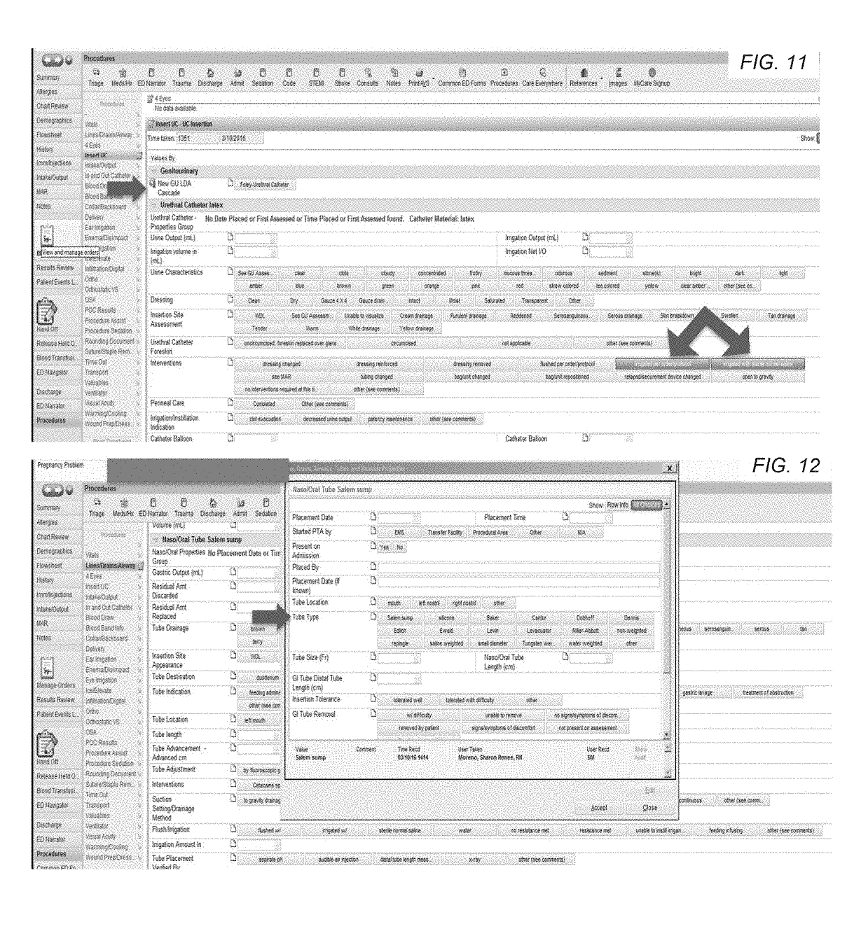

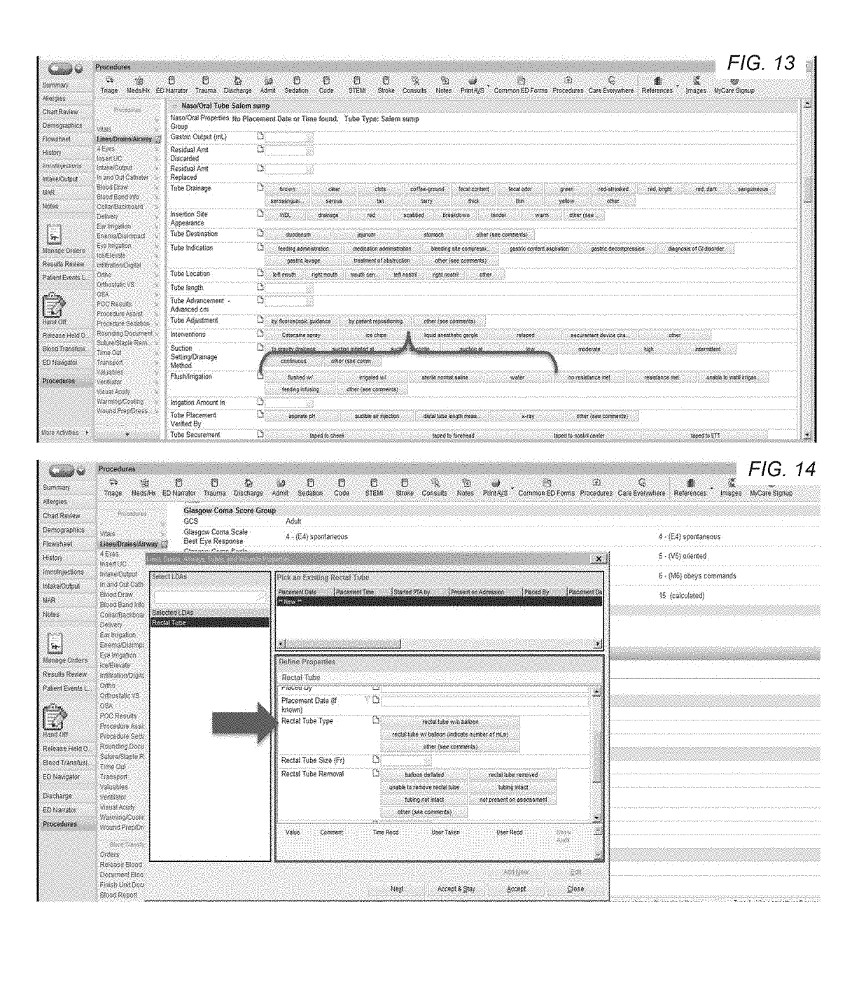

A further representative category of resources available with the systems, apparatuses, articles, and methods described herein for a visit of a patient to the ED is depicted in TABLE 4A, which is representative of patient interventions provided to the patient during the visit to the ED; the table provides such representative resources and their general description, the resources in TABLE 4A being those for which a value is imposed as described herein. For example, with foley insertion, its value may be imposed when foley type is selected (e.g., selection of such a resource in an electronic system or computer readable program code, which may be, or may be associated with, the system, apparatus, article, and/or method described herein) as depicted in FIG. 9 (and/or arrow(s) in the figure). Within and out catheter, its value may be imposed when catheter type is selected (e.g., selection of such a resource in an electronic system or computer readable program code, which may be, or may be associated with, the system, apparatus, article, and/or method described herein) as depicted in FIG. 10 (and/or arrow(s) in the figure). With bladder irrigation, its value may be imposed when selected (e.g., selection of such a resource in an electronic system or computer readable program code, which may be, or may be associated with, the system, apparatus, article, and/or method described herein) as depicted in FIG. 11 (and/or arrow(s) in the figure). With insertion of NG or OG tube, its value may be imposed after a tube type is selected (e.g., selection of such a resource in an electronic system or computer readable program code, which may be, or may be associated with, the system, apparatus, article, and/or method described herein) as depicted in FIG. 12 (and/or arrow(s) in the figure). With gastric lavage, its value may be imposed after a tube is placed and/or when irrigation pathway is chosen or performed (e.g., selection of such a resource in an electronic system or computer readable program code, which may be, or may be associated with, the system, apparatus, article, and/or method described herein) as depicted in FIG. 13 (and/or arrow(s) in the figure). With insertion of rectal tube, its value may be imposed after tube type is chosen (e.g., selection of such a resource in an electronic system or computer readable program code, which may be, or may be associated with, the system, apparatus, article, and/or method described herein) as depicted in FIG. 14 (and/or arrow(s) in the figure).

TABLE 4A

| | |
|---|---|
| Foley | Includes nursing time to maintain an existing foley or newly |
| insertion | inserted foley, includes monitoring of I/Os. |
| In/Out | Includes insertion of straight catheter for purposes of |
| catheter | obtaining a specimen. |
| Bladder | Includes implementation and/or monitoring of bladder |
| irrigation | irrigation due to bleeding in the bladder. |
| Insertion of | Includes placement of nasogastric or similar tube and/or |
| NG or OG | care of patient while in place, such as applying suction, |
| tube | measuring outputs, and maintaining correct position of tube |
| | and/or comfort measures to patient. |
| Gastric | Includes irrigation/lavage due to overdose or gastric |
| lavage | bleeding, and may include EWALD and/or ice water |
| | lavage. |
| Insertion of | Includes insertion of rectal tube for purposes of preventing |
| rectal tube | skin breakdown, and/or for patient comfort due to excessive |
| | diarrhea. |

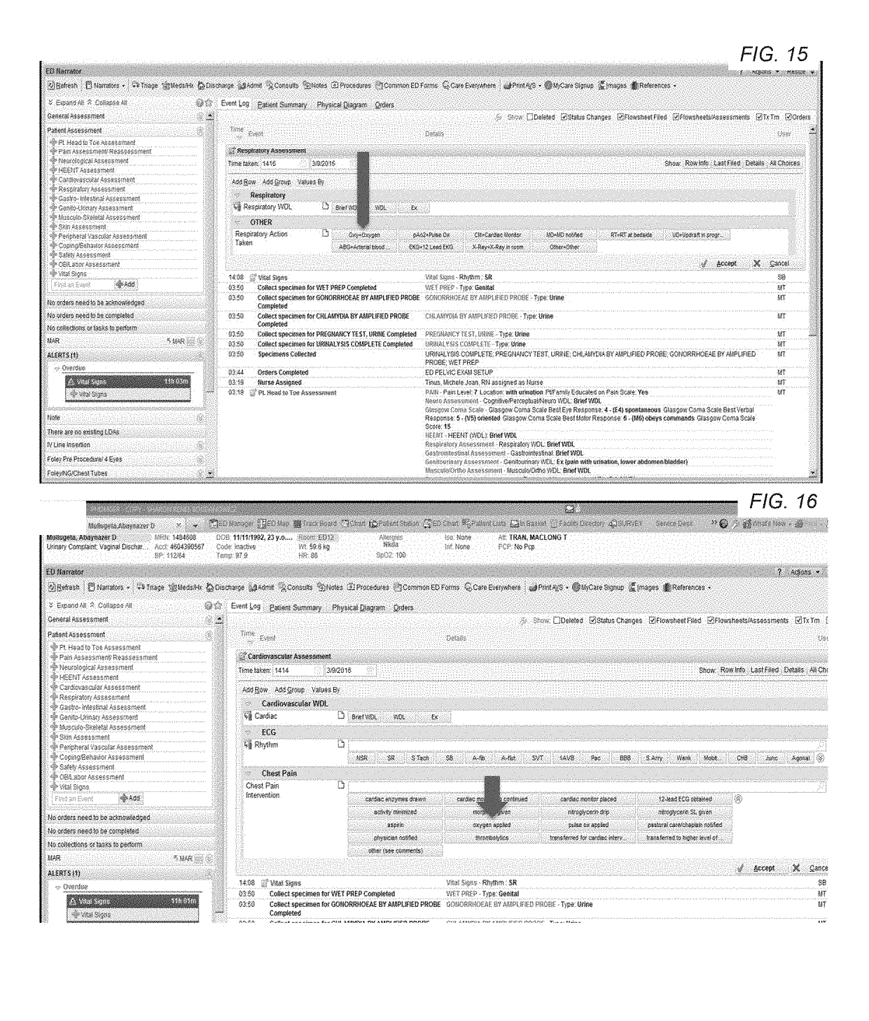

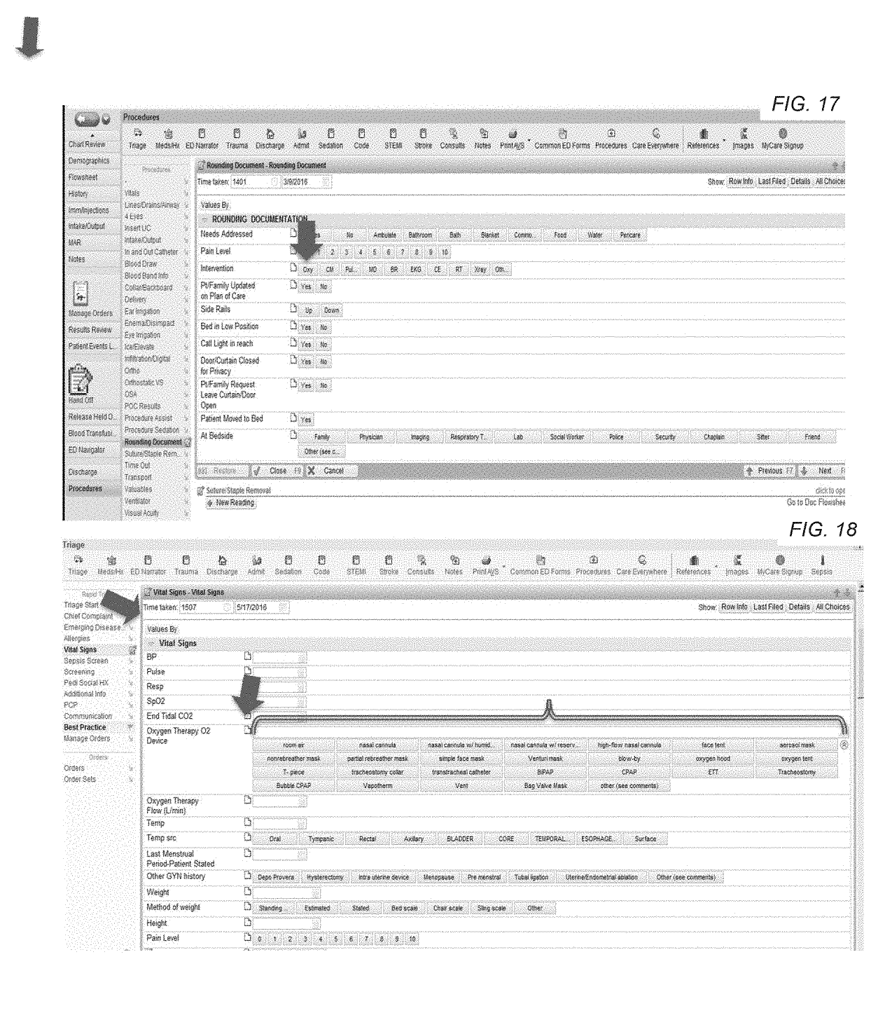

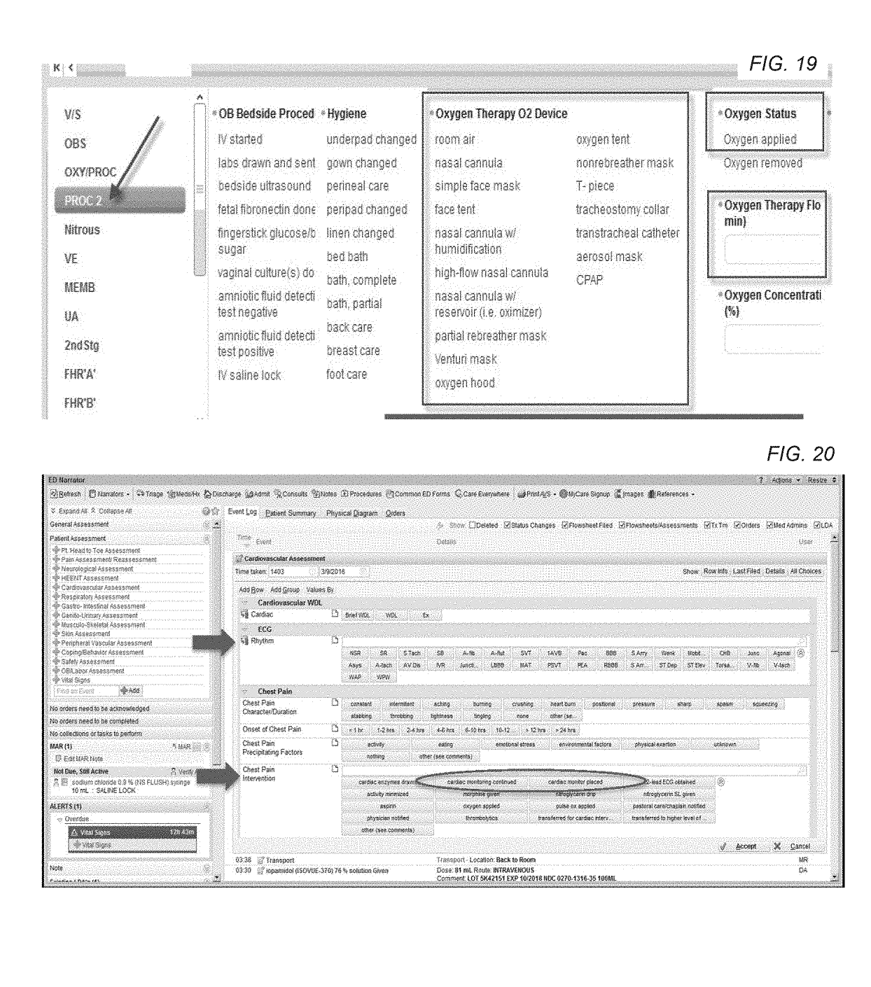

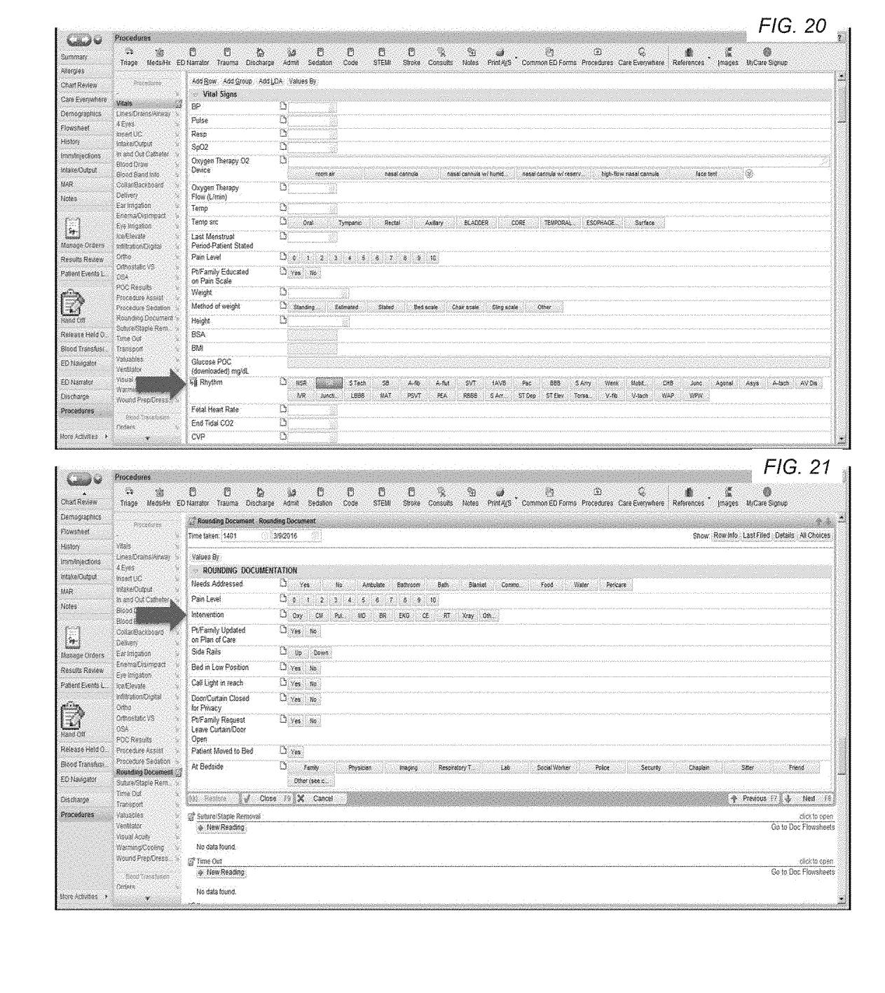

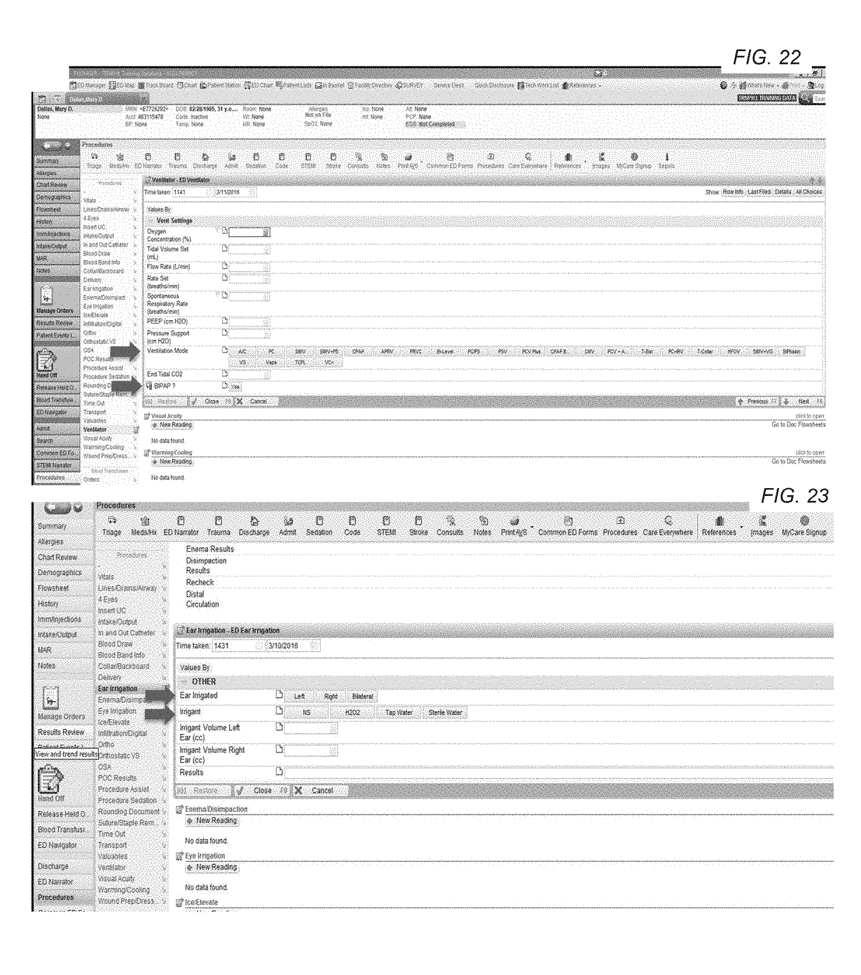

A further representative category of resources available with the systems, apparatuses, articles, and methods described herein for a visit of a patient to the ED is depicted in TABLE 4B, which is representative of additional patient interventions (those associated with the cardiopulmonary system) provided to the patient during the visit to the ED; the table provides such representative resources and their general description, the resources in TABLE 4B being those for which a value is imposed as described herein. For example, with oxygen, its value may be imposed when respiratory action is taken, and/or when (or after) oxygen is applied, and/or when an oxygen device is selected, and/or when oxygen status and/or flow (L/min) is entered (e.g., selection of such a resource in an electronic system or computer readable program code, which may be, or may be associated with, the system, apparatus, article, and/or method described herein) as depicted in FIGS. 15-19 (and/or arrow(s) in the figures). With cardiac monitor, its value may be imposed when the rhythm and/or type of intervention is selected (e.g., selection of such a resource in an electronic system or computer readable program code, which may be, or may be associated with, the system, apparatus, article, and/or method described herein) as depicted in FIGS. 20-21 (and/or arrow(s) in the figure). With ventilator, its value may be imposed when mode and/or bipap is selected (e.g., selection of such a resource in an electronic system or computer readable program code, which may be, or may be associated with, the system, apparatus, article, and/or method described herein) as depicted in FIG. 22 (and/or arrow(s) in the figure).

TABLE 4B

| | |
|---|---|
| Oxygen | Includes application of oxygen therapy. |
| Cardiac | Includes cardiac monitoring to assess cardiac status and |
| monitor | indications of any ongoing or new issues, such as |
| | interpretation of monitor strip and interventions as |
| | appropriate. |
| Ventilator | Includes use, for patient placed on a ventilator and |
| | supported mechanically during visit. |

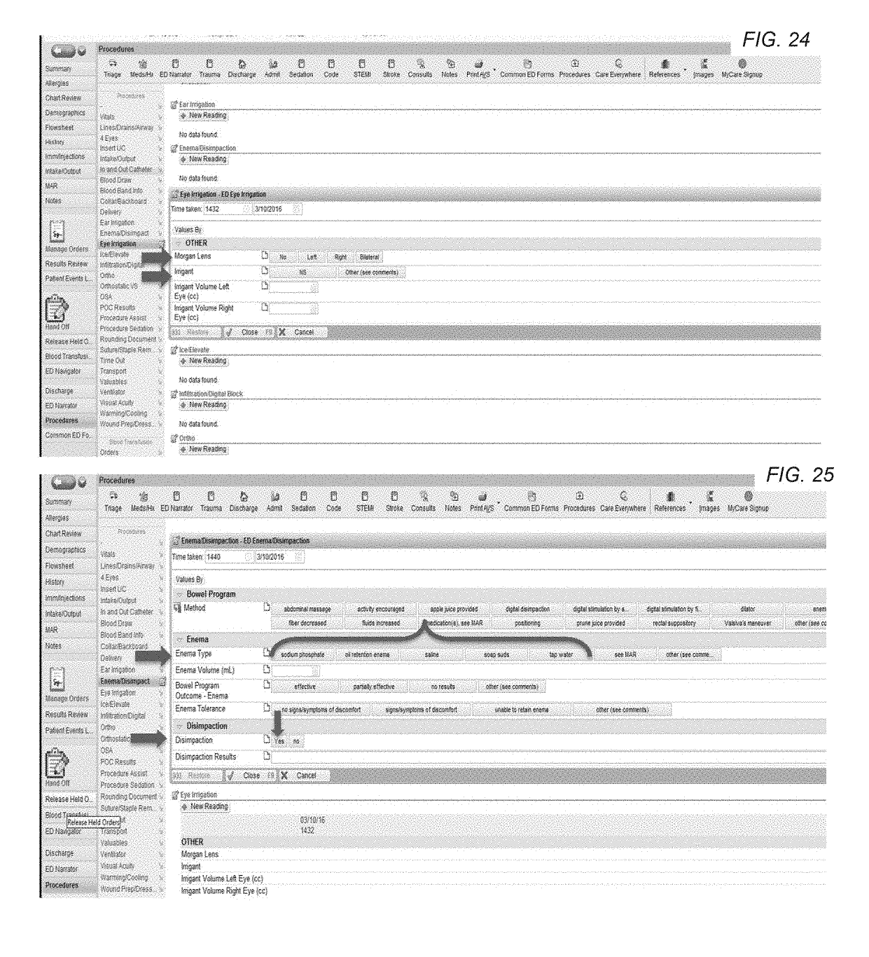

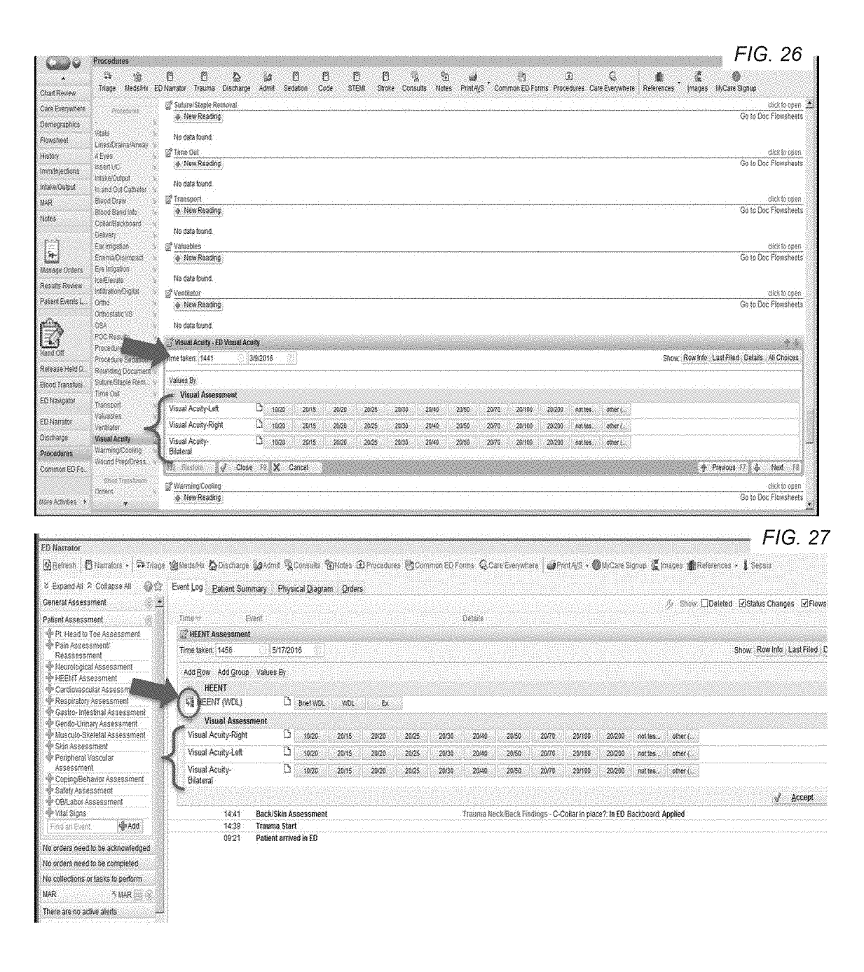

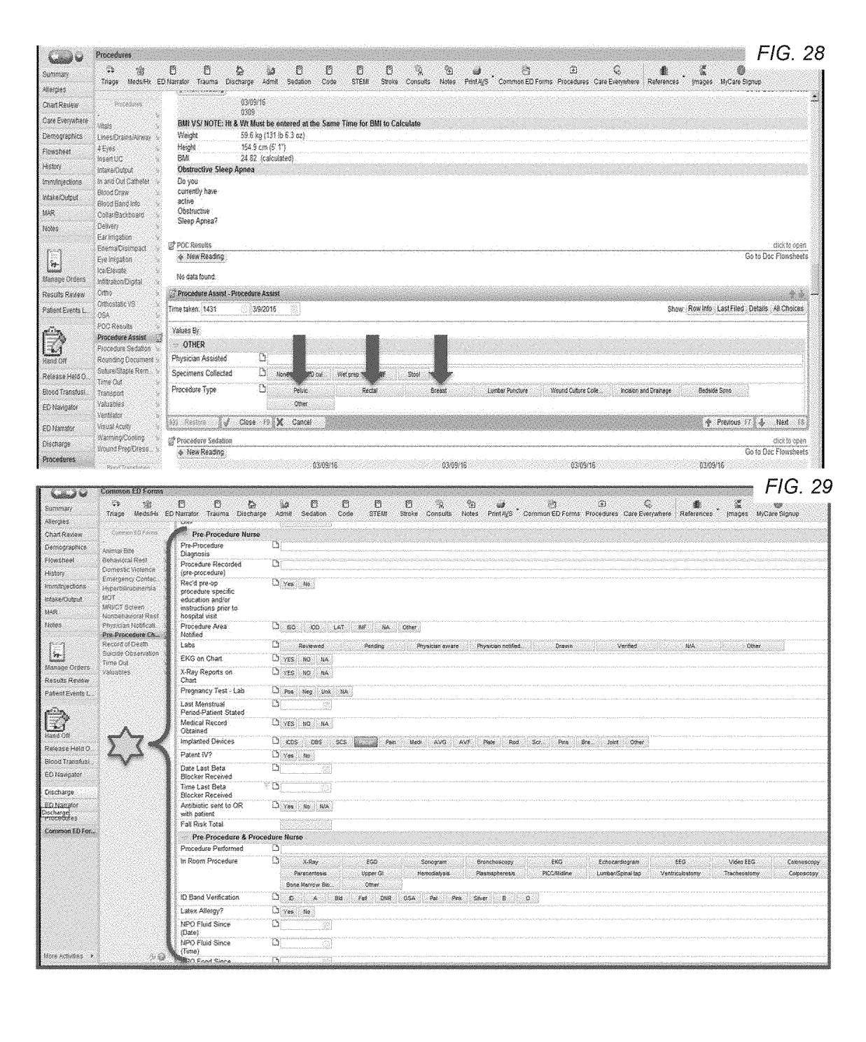

Still another further representative category of resources available with the systems, apparatuses, articles, and methods described herein for a visit of a patient to the ED is depicted in TABLE 5A, which is representative of specific procedures provided to the patient during the visit to the ED; the table provides such representative resources and their general description, the resources in TABLE 5A being those for which a value is imposed as described herein. For example, with ear irrigation, its value may be imposed when the action is selected and/or requested, and/or when an irrigant is chosen (e.g., selection of such a resource in an electronic system or computer readable program code, which may be, or may be associated with, the system, apparatus, article, and/or method described herein) as depicted in FIG. 23 (and/or arrow(s) in the figure). With eye irrigation, its value may be imposed when morgan lens and/or an irrigant is chosen (e.g., selection of such a resource in an electronic system or computer readable program code, which may be, or may be associated with, the system, apparatus, article, and/or method described herein) as depicted in FIG. 24 (and/or arrow(s) in the figure). With enemas/disimpaction, its value may be imposed when type and/or disimpaction is selected and/or requested (e.g., selection of such a resource in an electronic system or computer readable program code, which may be, or may be associated with, the system, apparatus, article, and/or method described herein) as depicted in FIG. 25 (and/or arrow(s) in the figure). With visual acuity, its value may be imposed when visual acuity and/or HEENT is selected (e.g., selection of such a resource in an electronic system or computer readable program code, which may be, or may be associated with, the system, apparatus, article, and/or method described herein) as depicted in FIGS. 26-27 (and/or arrow(s) in the figures). With exam assist (for rectal, pelvic, and/or breast), its value may be imposed when selected and/or requested (e.g., selection of such a resource in an electronic system or computer readable program code, which may be, or may be associated with, the system, apparatus, article, and/or method described herein) as depicted in FIG. 28 (and/or arrow(s) in the figure). With pre-procedure check, its value may be imposed when documented, selected and/or requested (e.g., selection of such a resource in an electronic system or computer readable program code, which may be, or may be associated with, the system, apparatus, article, and/or method described herein) as depicted in FIG. 29 (and/or arrow(s) in the figure).

TABLE 5A

| | |
|---|---|
| Ear | Includes irrigation of one or both ears, and may include |
| irrigation | continuous ear irrigation for wax removal. |
| Eye | Includes irrigation of one or both eyes, and may include |
| irrigation | continuous eye irrigation for chemical removal. |
| Enema/ | Includes procedure to relieve constipated stool through |
| Disimpaction | manual disimpaction digitally, and/or insertion of soap |
| | suds/fleets, etc., generally provided by RN. |
| Exam assist: | Includes non-separately billable procedures/exams; |
| pelvic | generally nursing documentation supports the procedure/ |
| | exam being performed. |
| Exam assist: | Includes non-separately billable procedures/exams; |
| rectal | generally nursing documentation supports the procedure/ |
| | exam being performed. |
| Exam assist: | Includes non-separately billable procedures/exams; |
| breast | generally nursing documentation supports the procedure/ |
| | exam being performed. |
| Visual | Includes visual acuity test with Snellen chart, recording |
| acuity | results and reporting to physician |
| Pre-procedure | Includes completing operative permit, patient |
| checklist | preparation, pre-operative prep, report to anesthesia |
| | and/or OR staff |

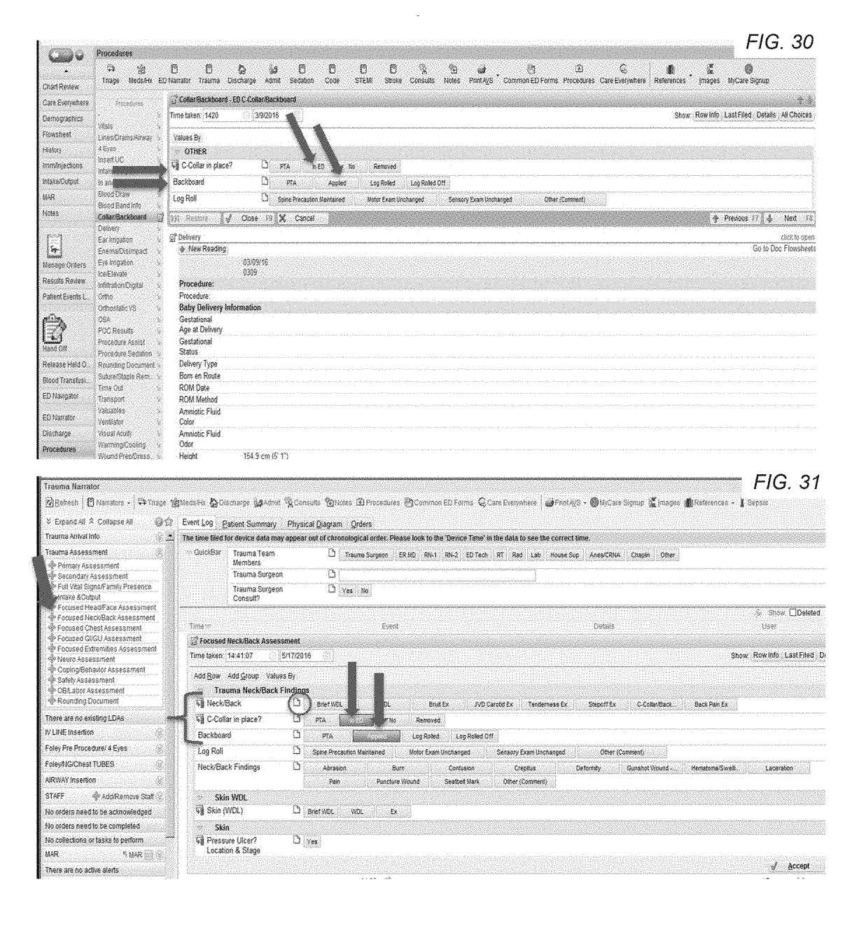

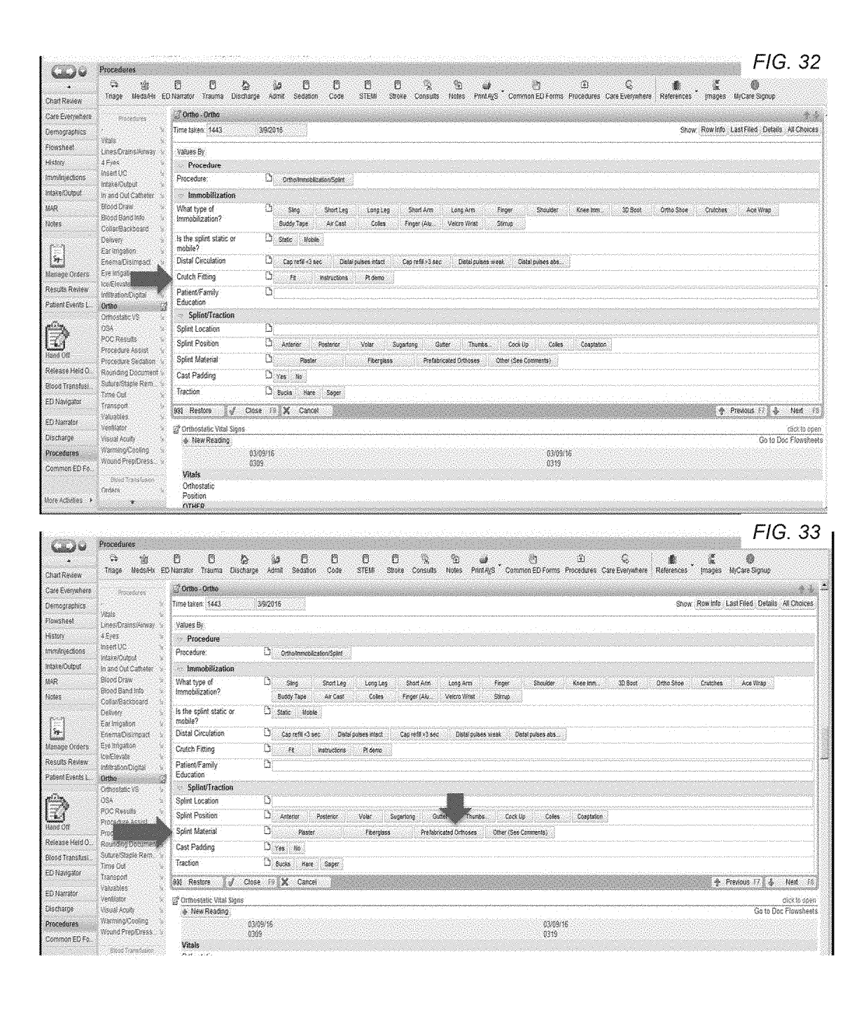

Still another further representative category of resources available with the systems, apparatuses, articles, and methods described herein for a visit of a patient to the ED is depicted in TABLE 5B, which is representative of specific procedures (those associated with orthopedics) provided to the patient during the visit to the ED; the table provides such representative resources and their general description, the resources in TABLE 5B being those for which a value is imposed as described herein. For example, with co-collar/backboard, its value may be imposed when selected and/or requested and/or applied (e.g., selection of such a resource in an electronic system or computer readable program code, which may be, or may be associated with, the system, apparatus, article, and/or method described herein) as depicted in FIGS. 30-31 (and/or arrow(s) in the figures). With crutch fitting and/or training, its value may be imposed when one is chosen and/or requested (e.g., selection of such a resource in an electronic system or computer readable program code, which may be, or may be associated with, the system, apparatus, article, and/or method described herein) as depicted in FIG. 32 (and/or arrow(s) in the figure). With ortho splint material and/or pre-fabricated orthoses, its value may be imposed when one is chosen and/or requested (e.g., selection of such a resource in an electronic system or computer readable program code, which may be, or may be associated with, the system, apparatus, article, and/or method described herein) as depicted in FIG. 33 (and/or arrow(s) in the figure).

TABLE 5B

| | |
|---|---|
| C-collar/ | Includes resources used for application and/or placement |
| Backboard | of c-collar and backboard, such as for trauma patients. |
| Crutch | Includes fitting and/or teaching of how to walk with |
| | crutches, and may include return demonstration. |
| Pre-fabricated | Includes application of prefabricated splints from stock, |
| orthoses | includes patient teaching for splint use and reapplication. |

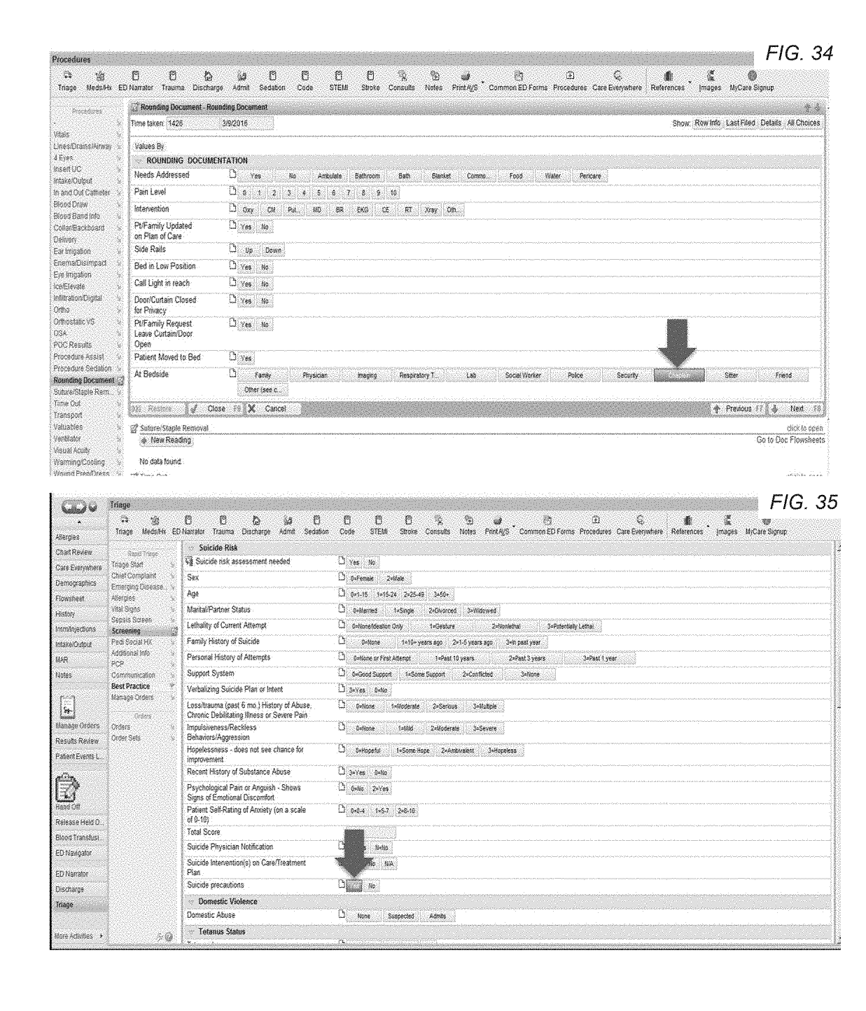

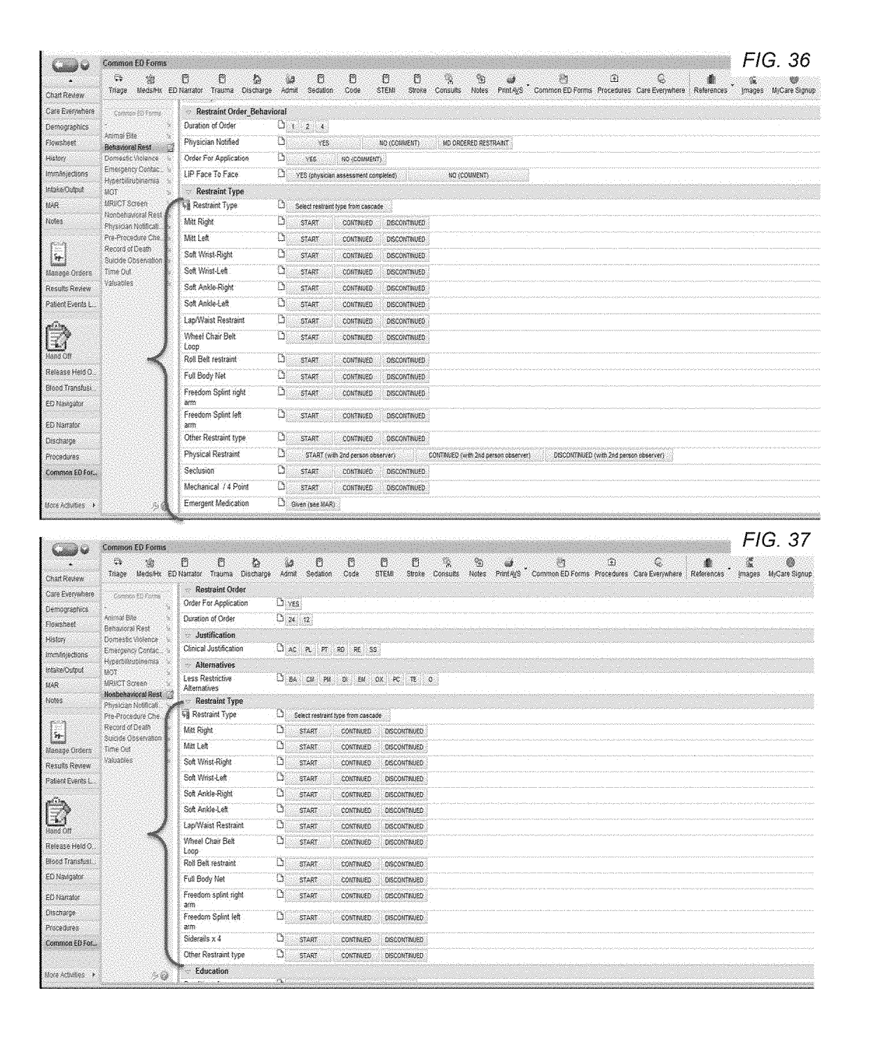

Yet another representative category of resources available with the systems, apparatuses, articles, and methods described herein for a visit of a patient to the ED is depicted in TABLE 5C, which is representative of specific procedures (those associated with psychiatric work, social work and/or safety/precautions) provided to the patient during the visit to the ED; the table provides such representative resources and their general description, the resources in TABLE 5C being those for which a value is imposed as described herein. For example, with extended family support, its value may be imposed when selected and/or requested and/or applied (e.g., selection of such a resource in an electronic system or computer readable program code, which may be, or may be associated with, the system, apparatus, article, and/or method described herein) as depicted in FIG. 34 (and/or arrow(s) in the figure). With suicide precaution, its value may be imposed when one is chosen and/or requested (e.g., selection of such a resource in an electronic system or computer readable program code, which may be, or may be associated with, the system, apparatus, article, and/or method described herein) as depicted in FIG. 35 (and/or arrow(s) in the figure). With behavioral restraints, its value may be imposed when a type is chosen and/or requested (e.g., selection of such a resource in an electronic system or computer readable program code, which may be, or may be associated with, the system, apparatus, article, and/or method described herein) as depicted in FIG. 36 (and/or arrow(s) in the figure). With non-behavioral restraints, its value may be imposed when a type is chosen and/or requested (e.g., selection of such a resource in an electronic system or computer readable program code, which may be, or may be associated with, the system, apparatus, article, and/or method described herein) as depicted in FIG. 37 (and/or arrow(s) in the figure).

TABLE 5C

| | |
|---|---|
| Extended | Includes more than average support required for reassuring, |
| family | supporting patient and/or family (e.g., grief or other support |
| support | worker and/or chaplain); usually associated with extreme |
| | situations such as a death, suicide, rape, or other significant |
| | events; may include difficult social service and/or emotional |
| | support cases. |
| Suicide | Includes implementation of suicide precautions for patient |
| precaution | who poses threat to themselves and/or others; general a |
| | suicide risk assessment must be filled out/included. |
| Restrain - | Includes application of restraint, monitoring of the restrained |
| behavioral | patient and assisting the patient with mobility needs within the |
| type | department. Direct observation and/or manual restraint of |
| | combative patient. |
| Restrain - | Includes application of restraint, monitoring of the restrained |
| non- | patient and assisting the patient with mobility needs within the |
| behavioral | department |
| type | |

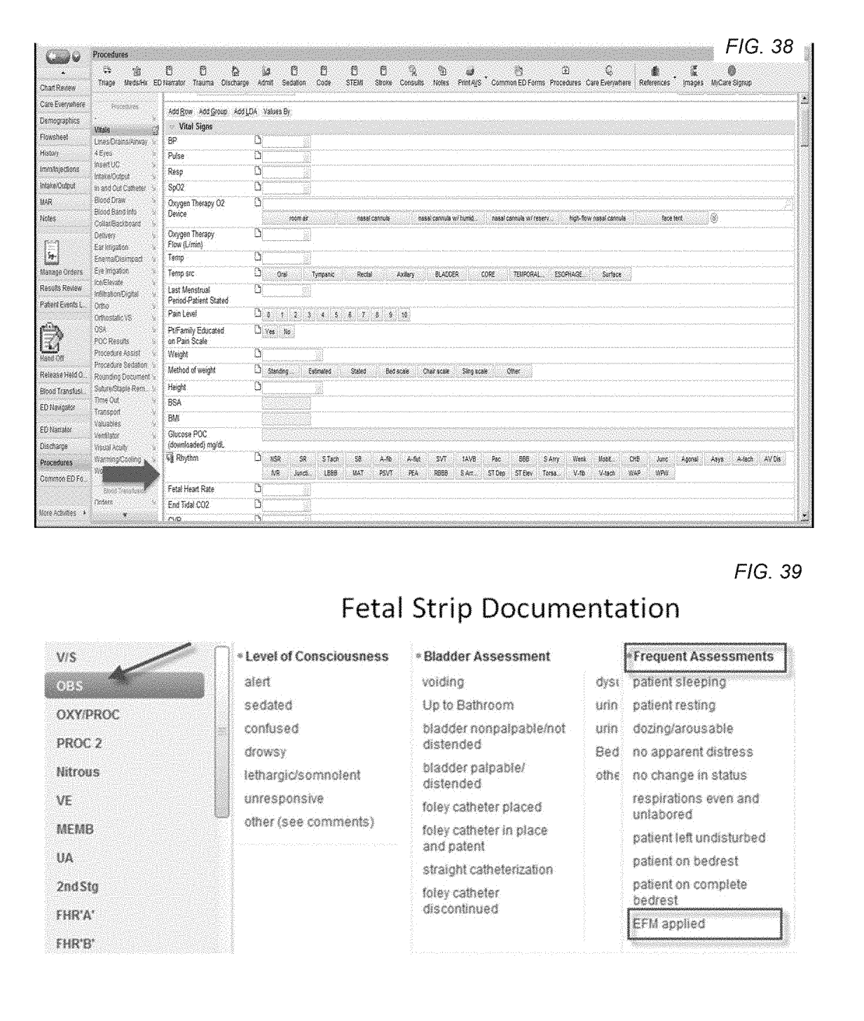

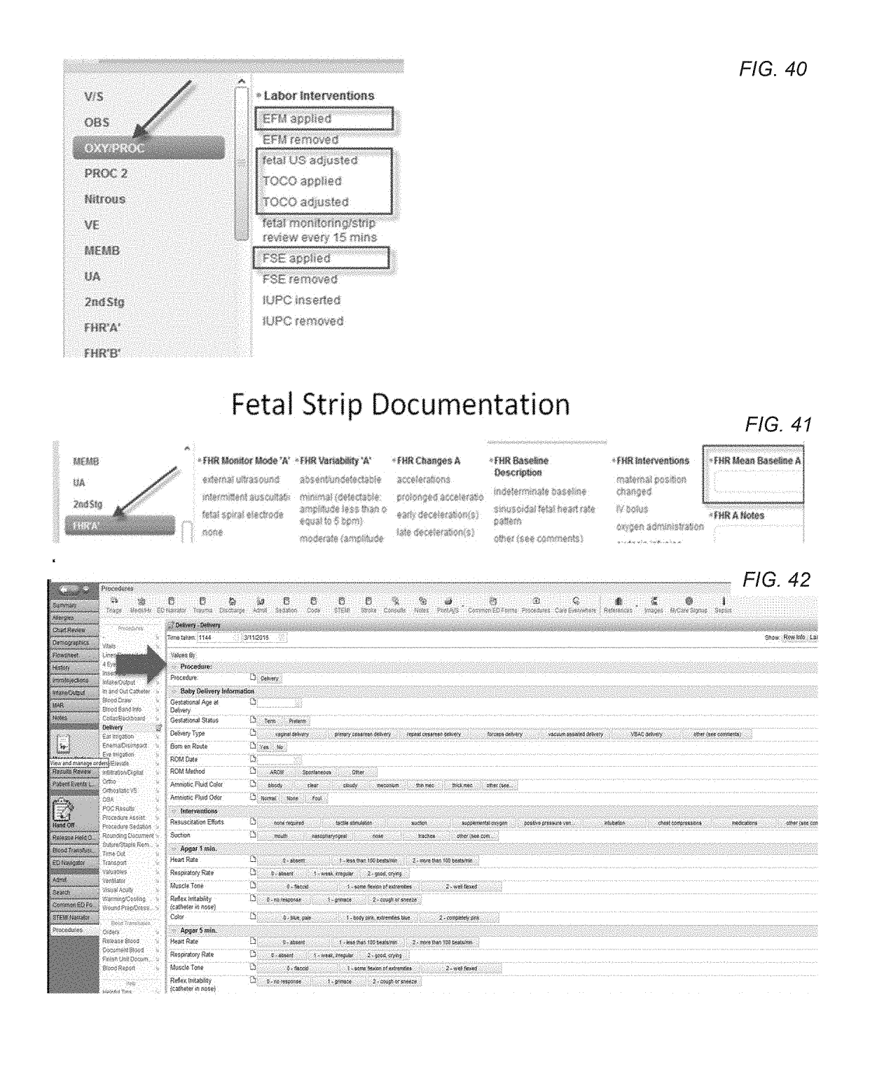

Still a further representative category of resources available with the systems, apparatuses, articles, and methods described herein for a visit of a patient to the ED is depicted in TABLE 5D, which is representative of specific procedures (those associated with pregnancy) provided to the patient during the visit to the ED; the table provides such representative resources and their general description, the resources in TABLE 5D being those for which a value is imposed as described herein. For example, with fetal heart tone, its value may be imposed when a heart rate is entered, and/or when fetal monitor is documented and/or applied and/or adjusted (e.g., selection of such a resource in an electronic system or computer readable program code, which may be, or may be associated with, the system, apparatus, article, and/or method described herein) as depicted in FIGS. 38-41 (and/or arrow(s) in the figures). With delivery, its value may be imposed when a procedure is chosen and/or requested (e.g., selection of such a resource in an electronic system or computer readable program code, which may be, or may be associated with, the system, apparatus, article, and/or method described herein) as depicted in FIG. 42 (and/or arrow(s) in the figure).

TABLE 5D

| | |
|---|---|
| Fetal heart tone | Includes monitoring on arrival, and/or as appropriate. |
| Delivery- | Includes any delivery from conception. |
| precipitous | |

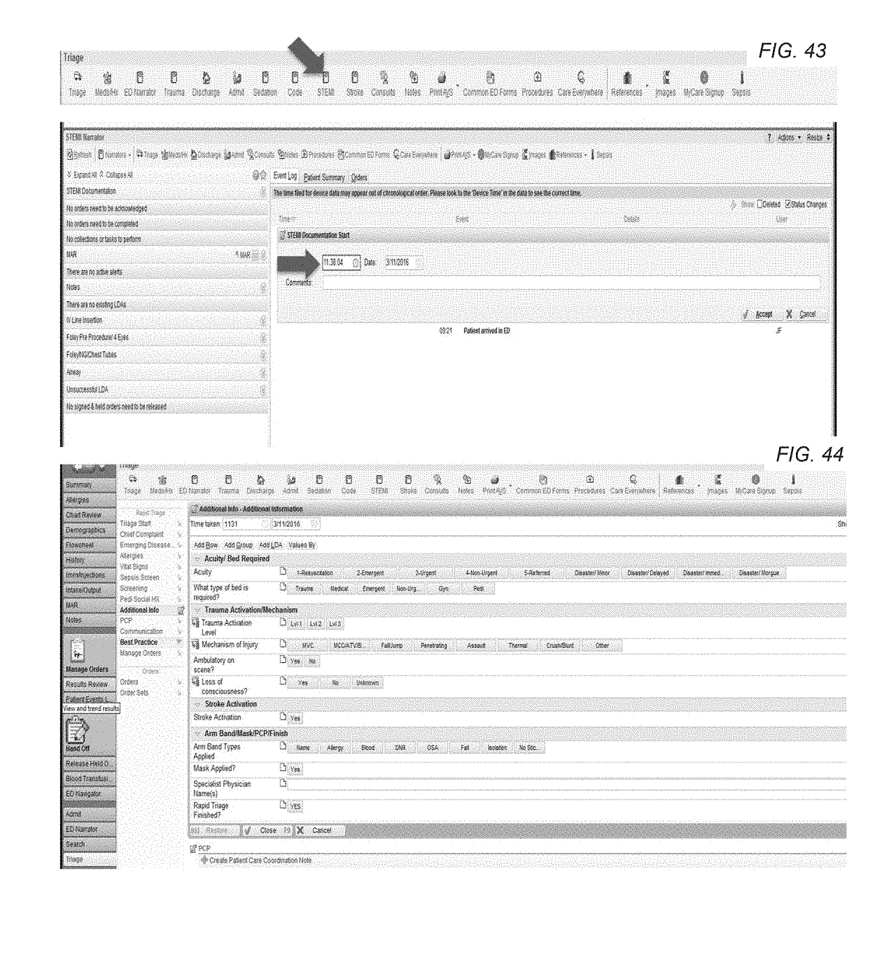

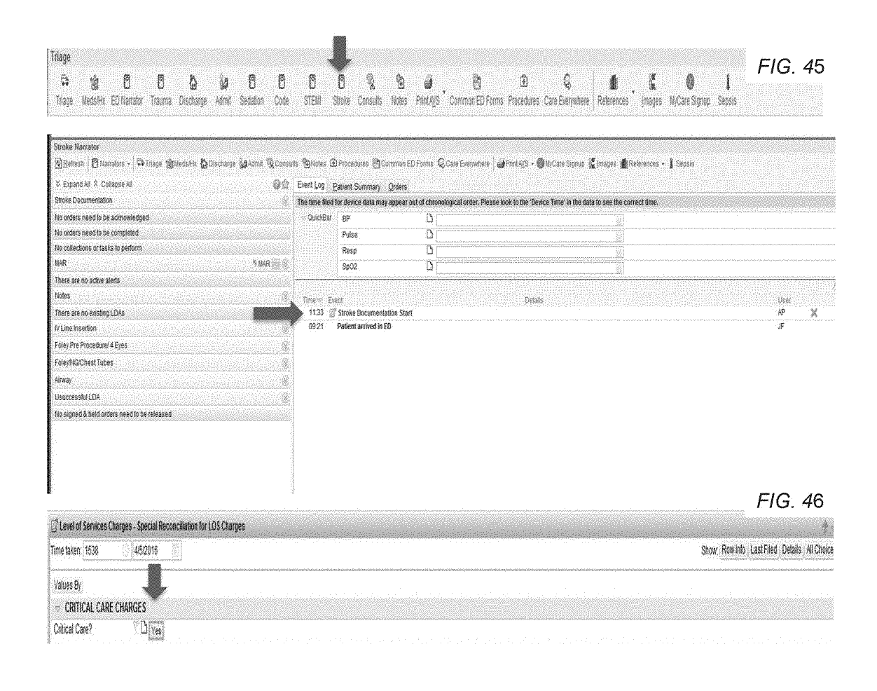

A further representative category of resources available with the systems, apparatuses, articles, and methods described herein for a visit of a patient to the ED is depicted in TABLE 5E, which is representative of specific procedures (those associated with STEMI or stroke) provided to the patient during the visit to the ED; the table provides such representative resources and their general description, the resources in TABLE 5E being those for which a value is imposed as described herein. For example, with STEMI activation, its value may be imposed when an appropriate protocol is activated and/or requested (e.g., selection of such a resource in an electronic system or computer readable program code, which may be, or may be associated with, the system, apparatus, article, and/or method described herein) as depicted in FIG. 43 (and/or arrow(s) in the figure). With stroke activation, its value may be imposed when an appropriate protocol is activated and/or requested (e.g., selection of such a resource in an electronic system or computer readable program code, which may be, or may be associated with, the system, apparatus, article, and/or method described herein) as depicted in FIGS. 44-45 (and/or arrow(s) in the figures). With critical care, its value may be imposed when an appropriate protocol is activated and/or requested, and/or may be accompanied by a time period for which one or more resources are utilized during critical care (e.g., selection of such one or more resources in an electronic system or computer readable program code, which may be, or may be associated with, the system, apparatus, article, and/or method described herein, and may be accompanied by a period of time with such one or more resources) as depicted in FIG. 46 (and/or arrow(s) in the figure).

TABLE 5E

| | |
|---|---|
| STEMI | Includes protocol for MI activation. |
| activation | |
| Stroke | Includes protocol for one or more of cardiovascular accident |
| activation | (CVA) or stroke activation. |

A further representative category of resources available with the systems, apparatuses, articles, and methods described herein for a visit of a patient to the ED is depicted in TABLE 5F, which is representative of a specific procedure associated with critical care, provided to the patient during the visit to the ED; the table provides such representative resources and their general description, the resources in TABLE 5F being those for which a value is imposed as described herein. With critical care, its value may be imposed when an appropriate or specific protocol for critical care is activated and/or requested, and/or may be accompanied by a time period the procedure is implemented (e.g., selection of such one or more resources associated with critical care in an electronic system or computer readable program code, which may be, or may be associated with, the system, apparatus, article, and/or method described herein, and may be accompanied by a period of time with such one or more resources) as depicted in FIG. 46 (and/or arrow(s) in the figure).

TABLE 5F

| | |
|---|---|
| Critical | Includes critical care-evaluation and management of the |
| care | critically ill or critically injured patient; first 30-74 |
| | minutes, such a life threatening illnesses/symptoms/injuries, |
| | generally requiring 1:1 nursing or ancillary care, and generally |
| | uses the most extensive resources (e.g., respiratory failure, |
| | CPR, multi-system trauma); generally documentation must |
| | support critical care resources (e.g., vital sign, assessment, |
| | ventilator setting, medication(s), NG tube insertion, intubation) |
| | for a particular time period; critical care may be associated |
| | with one or more codes identifying the period of time that |
| | critical care resources are utilized (e.g., <30 min, 30-74 min., |
| | 75-104 min., 105-134 min., 135-164 min., 165-194 |
| | min., >195 min.) |

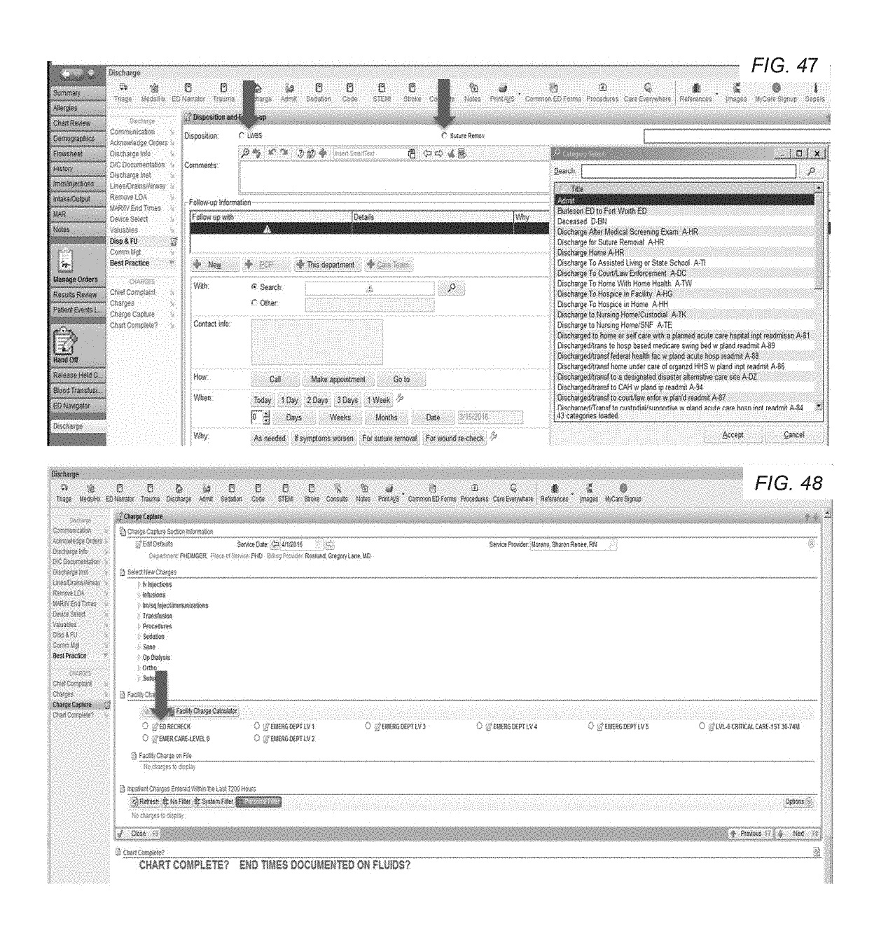

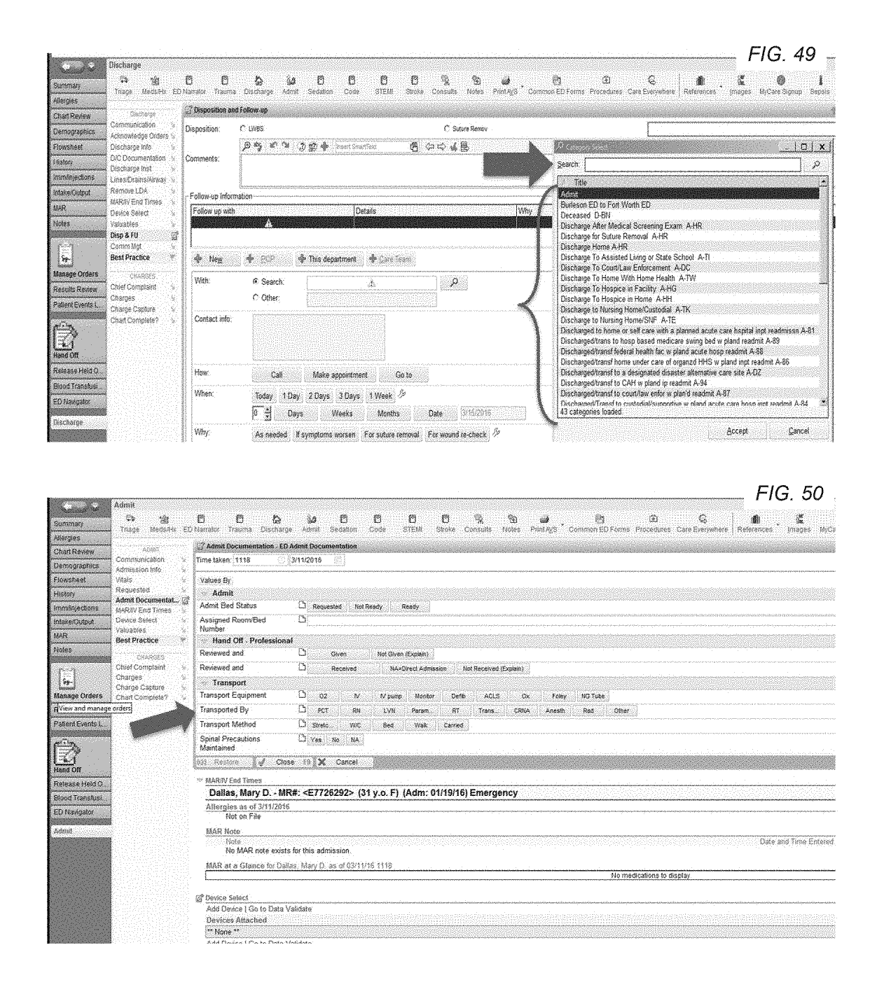

Yet a further representative category of resources available with the systems, apparatuses, articles, and methods described herein for a visit of a patient to the ED is depicted in TABLE 6, which is representative of disposition of the patient at the end of the visit to the ED; the table provides such representative resources and their general description, the resources in TABLE 6 being those for which a value is imposed as described herein. Most of the dispositions must be identified and/or completed and/or entered and/or selected by a physician. For example, with LWBS or suture/staple removal or re-check (level 0), its value may be imposed when no physician is required, or when patient is absent before physician arrival (e.g., selection of such a resource in an electronic system or computer readable program code, which may be, or may be associated with, the system, apparatus, article, and/or method described herein) as depicted in FIGS. 47-48 (and/or arrow(s) in the figures). For example, re-check (level II), its value may be imposed a physician is required (e.g., selection of such a resource in an electronic system or computer readable program code, which may be, or may be associated with, the system, apparatus, article, and/or method described herein) as depicted in FIG. 48 (and/or arrow(s) in the figure). With admission and/or transfer and/or discharge and/or deceased and/or return to nursing home, its value may be imposed when chosen and/or completed and/or requested and/or selected, generally by a physician (e.g., selection of such a resource in an electronic system or computer readable program code, which may be, or may be associated with, the system, apparatus, article, and/or method described herein) as depicted in FIG. 49 (and/or arrow(s) in the figure). With AMA elopement, its value may be imposed when chosen and/or completed and/or requested and/or selected, generally by a physician (e.g., selection of such a resource in an electronic system or computer readable program code, which may be, or may be associated with, the system, apparatus, article, and/or method described herein). With RN/Paramedic transport, its value may be imposed when documented and/or chosen and/or requested and/or selected (e.g., selection of such a resource in an electronic system or computer readable program code, which may be, or may be associated with, the system, apparatus, article, and/or method described herein) as depicted in FIG. 50 (and/or arrow(s) in the figure).

TABLE 6

| | |
|---|---|
| Leaving | Includes leaving before MD arrival/exam, or before being |
| without | seen by MD, or for suture and/or staple removal which does |
| being seen | receive an MD exam; excludes re-checks in which there is |
| (LWBS) or | interaction with a physician (e.g., excludes wound re-check, |
| suture | wound re-dress, appendicitis re-check, rash, packing |
| removal | removal, health check for possible inpatient admission, |
| | return for positive blood count, all of which require |
| | interaction with physician) |
| Discharge | Includes basic and uncomplicated aftercare instructions. |
| Admit | Includes procedures necessary for patient admission, such |
| | as preparing chart, calling report to accepting nurse, |
| | arrangement of services. |
| Return | Includes procedures necessary for transferring a patient |
| to nursing | back to nursing home, including making copies of |
| home | paperwork, calling report to accepting nurse, and obtaining |
| | transportation. |
| Transfer | Includes procedures necessary for completing legal transfer, |
| | such as prepare chart, arranging or preparing for MOT, |
| | acceptance confirmation, calling report to accepting nurse, |
| | transportation arrangements. |
| Deceased | Includes death of patient, post mortem care, funeral home/ |
| | ME office notification, and/or calling of transplant services. |
| AMA | Includes when a patient has seen a physician and leaves |
| elopement | before the treatment is completed, and/or leaves against |
| | medical advice (AMA). When patient has received one or |
| | more resources (e.g., diagnostic services) before leaving, |
| | such resources are imposed for the visit. |
| RN/ | Includes when transporting patient to nursing unit/ancillary |
| Paramedic | department is required of nurse or paramedic |
| transport | |
| Re-check | Includes return of patient for suture removal where no |
| (level 0) | physician interaction is required and only minimal (triage) |
| | interaction (e.g., with nurse, and solely for suture removal). |
| Re-check | Includes return of patient in which physical interaction is |
| (level II) | required (e.g., wound re-check, wound re-dress, |
| | appendicitis re-check, rash, packing removal, health check |
| | for possible inpatient admission, return for positive blood |
| | count); includes minimal/limited physician interaction, |
| | and some nursing interaction; any further interaction |
| | not-covered by the scheduled visit or not from the initial |
| | visit is considered new visit. When the patient is called |
| | back due to missed diagnoses or because of additional |
| | information impacting the patient, any further resources |
| | are added to the previous visit. When the patient visits |
| | with a new reason, a new visit is initiated. |

Should a resource be selected based on a request from law enforcement, as depicted in FIG. 51 (and/or arrow(s) in the figure), a separate value may be imposed.

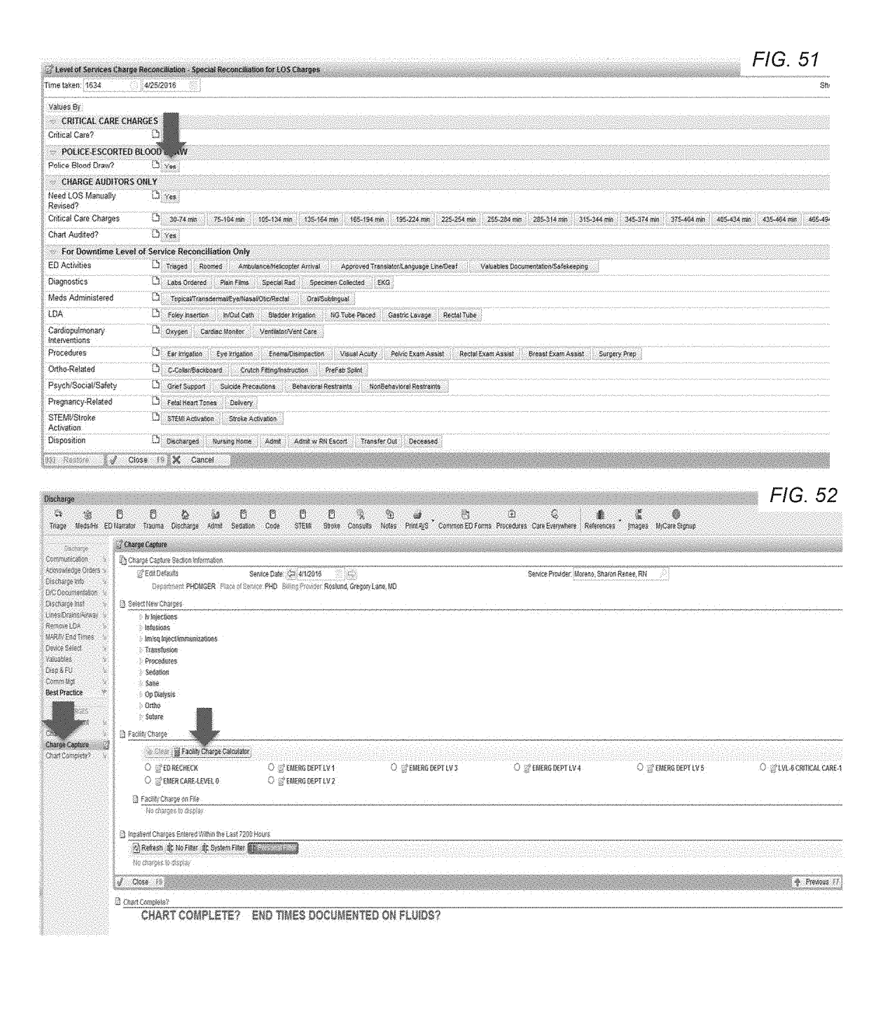

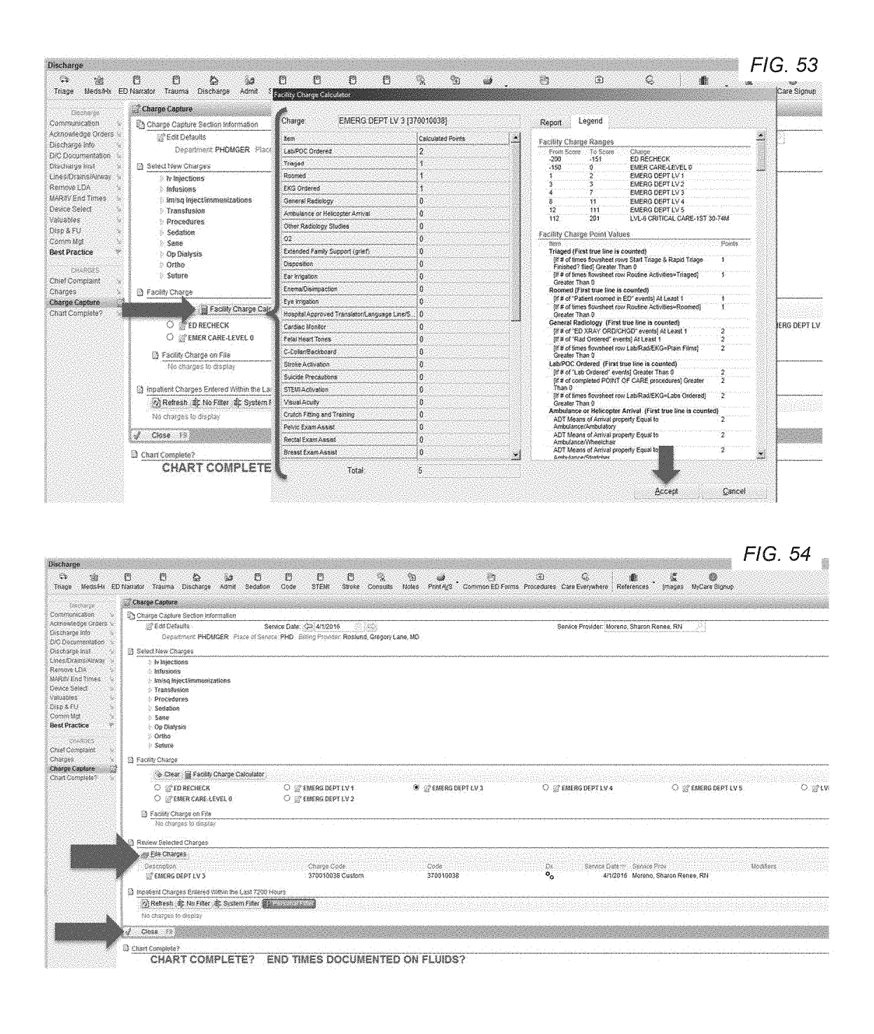

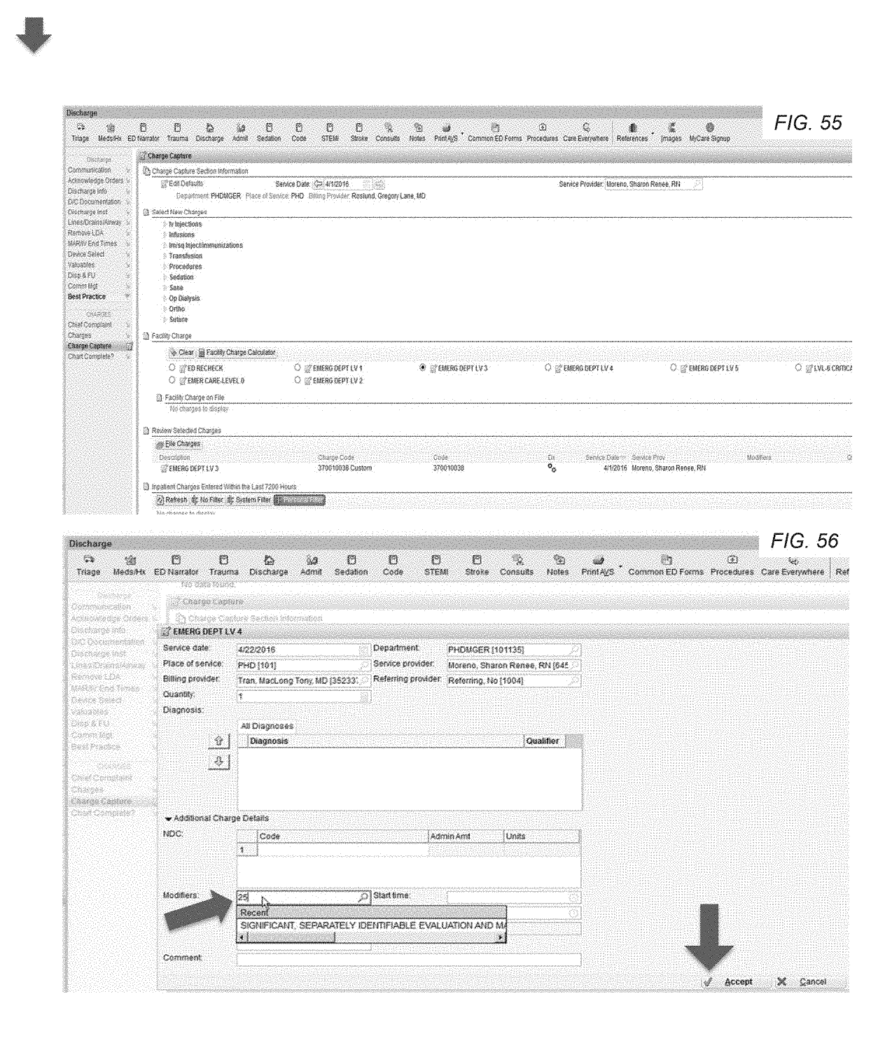

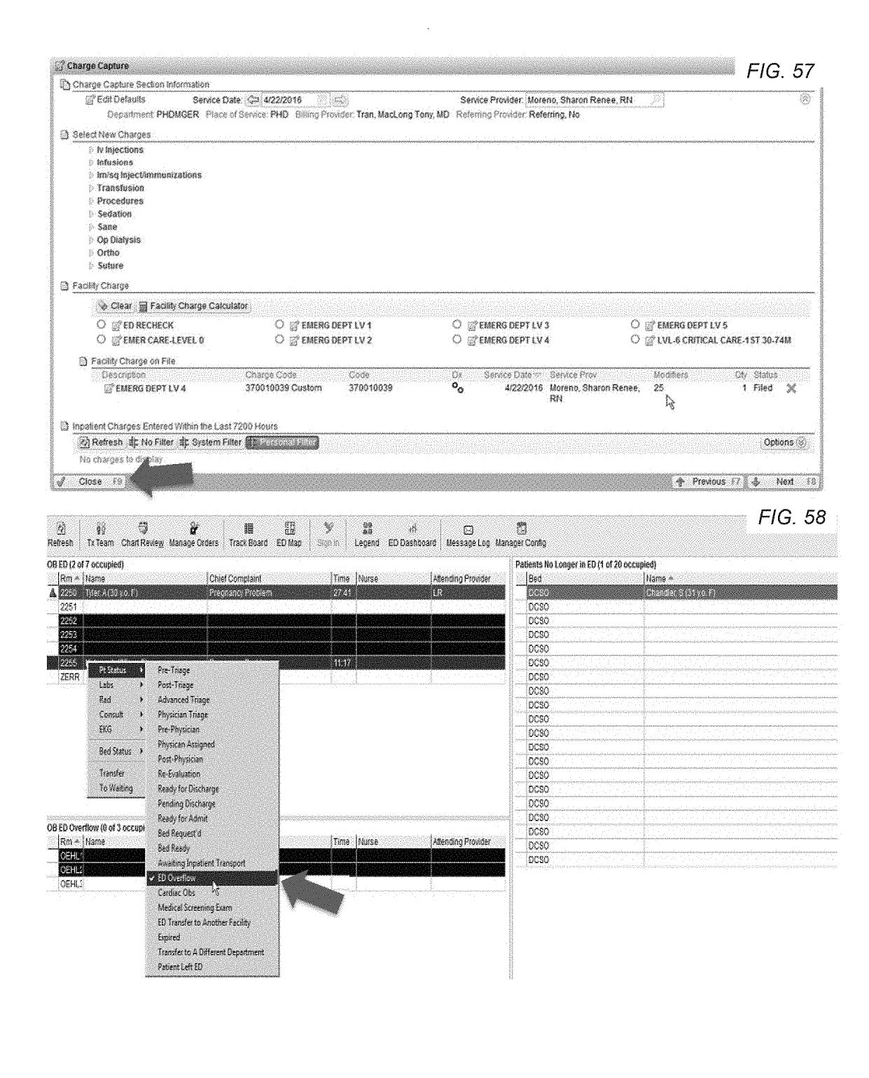

In some, a modifier may be imposed (e.g., via the resource calculator) for a visit in which one or more resources is imposed. In one or more embodiments, no modifier is imposed when the visit does not impose any resources, or when only certain resources are imposed (e.g., venipuncture, lab studies, plain film x-ray), as depicted in FIGS. 52-54 (and/or arrow(s) in the figures). In one or more embodiments, the modifier is imposed when the visit includes any other resources for which a value is imposed, as depicted in FIGS. 55-57 (and/or arrow(s) in the figures).

In one or more embodiments, the resource value calculator will not impose a value, or will not impose a further value, in the following situations: (i) when patient is moved out of the ED bed to another area (e.g., D/C area); (ii) when patient is discharged; (iii) when patient is admitted; (iv) when a nurse assigns the patient to a bed in new area (e.g., department); (v) when a patient is moved for different care (e.g., surgery, catheter lab); (vi) when a patient is placed in overflow; (vii) when orders have been written/completed by a physician, and the patient is in “inpatient hold” in the department, such as the ED. An example of stopping the resource value calculator is depicted in FIG. 58 (and/or arrow(s) in the figure). In one or more embodiments, the resource calculator will provide an adjustment when no further values are imposed and/or when any of the situations of (i) to (vii) are implemented.

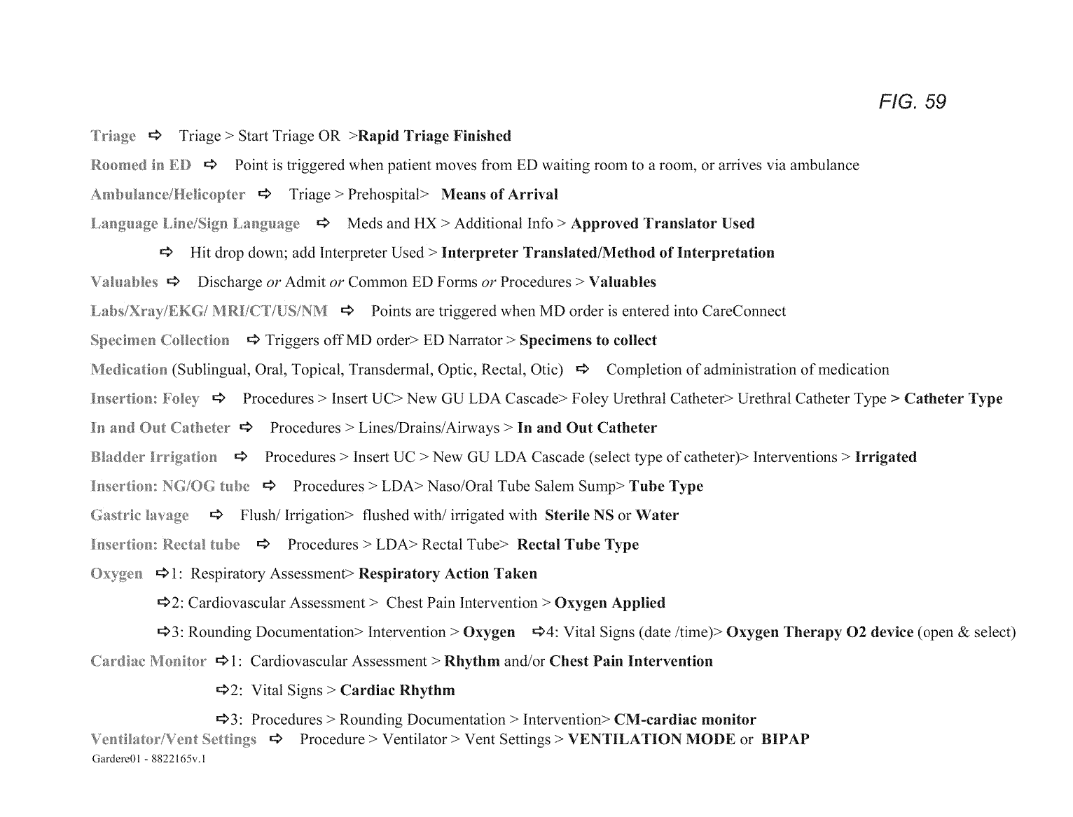

Some representative pathways for when a value is imposed, and/or representative steps utilized to trigger a value to be imposed, as described herein, and/or as correlated with and/or associated with a resource as identified in TABLES 1-6 are depicted in FIG. 59.

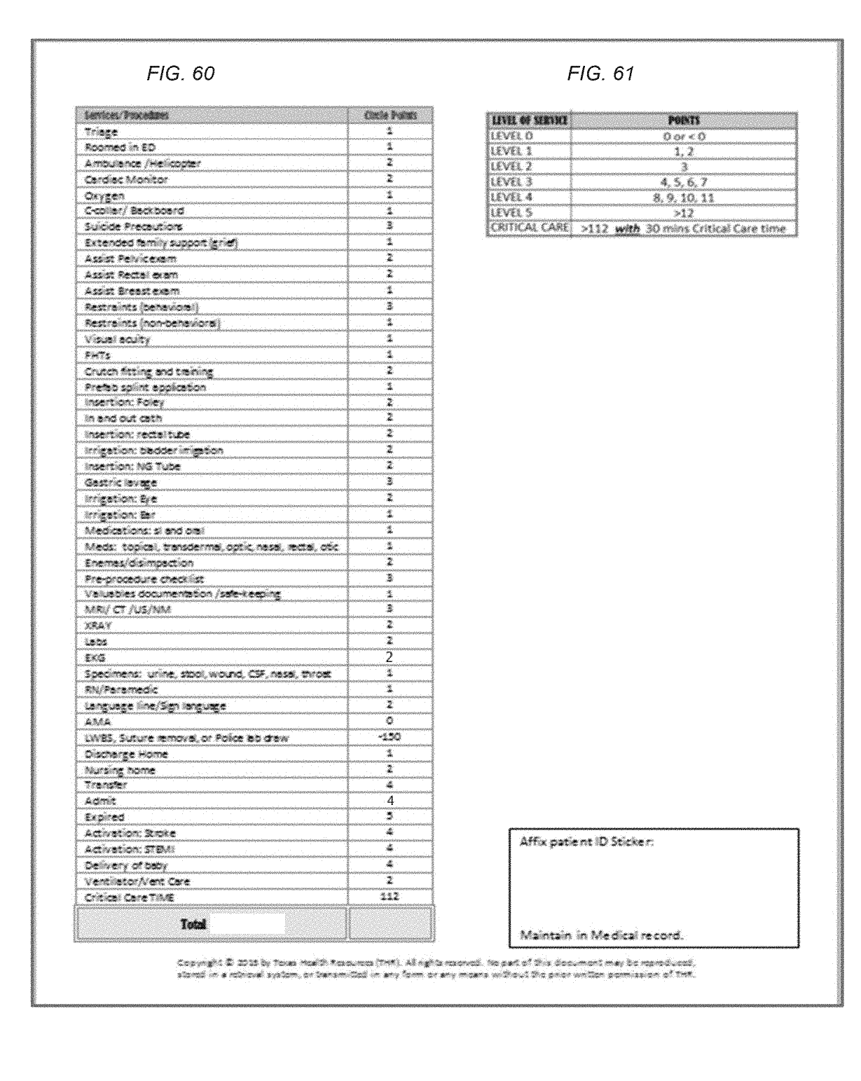

Representative values imposed with associated resources, those that impose a value as described herein, are depicted in FIG. 60. In one or more embodiments, selection of a resource, such as depicted in FIG. 60, will impose a greater value when the resource is associated with more personnel and/or one or more tools (medicament, equipment, and/or medical device). In one or more embodiments, selection of a resource, such as depicted in FIG. 60, will impose a greater value when the resource is associated with more personnel and/or one or more tools, in which such tool(s) require additional labor, expertise and/or training and/or personnel, and/or are costly. In one or embodiments, such as depicted in FIG. 60, selection of a resource will impose a value that is less than 10. In one or embodiments, such as depicted in FIG. 60, selection of a resource will impose a value that is less than 10, unless the resource is associated with critical care, which will impose a value greater than 10, or greater than 50 or greater than 100. In one or embodiments, such as depicted in FIG. 60, selection of a resource will impose a value that is less than 5, unless the resource is associated with critical care, which will impose a value greater than 10, or greater than 50 or greater than 100. In one or embodiments, such as depicted in FIG. 60, selection of a resource will impose a value that is between 1 and 2, unless the resource is associated with more than one personnel and/or one or more tools in which such tool(s) are labor intensive, require more expertise and/or training and/or personnel, and/or are costly, such as, but not limited to suicide precaution, pre-procedure checklist, gastric lavage, MRI/CT/US/NM, transfer, admit, deceased/expired, stroke activation, STEMI activation, delivery. Additionally, a value associated may be adjusted for patients admitted to telemetry or ICU for constant monitoring of care.

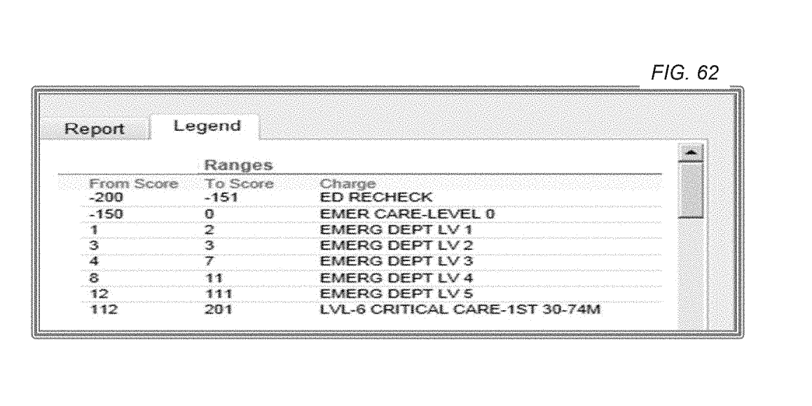

In one or more embodiments, when a stop is imposed on the resource value calculator, the resource value calculator provides an adjustment. In one or more embodiments, the adjustment may be in the form of points or scores as depicted in FIGS. 61 and 62. FIGS. 61 and 62 further shows that, as described herein, points or scores are a means by which a level of service is identified based on the adjustment. For example, in the representation of FIG. 61, no points are associated with a Level 0 for the level of service for a patient visit to the ED. In the representation of FIG. 61, 1 to 2 points are associated with a Level 1 for the level of service for a patient visit to the ED. In the representation of FIG. 61, 3 points are associated with a Level 2 for the level of service for a patient visit to the ED. In the representation of FIG. 61, 4-7 points are associated with a Level 3 for the level of service for a patient visit to the ED. In the representation of FIG. 61, 8-11 points are associated with a Level 4 for the level of service for a patient visit to the ED. In the representation of FIG. 61, 12 or greater than 12 points are associated with a Level 5 for the level of service for a patient visit to the ED. In the representation of FIG. 61, >112 points are associated with a Level Critical Care for the level of service for a patient visit to the ED.

In one or more embodiments, a value associated with each resource is triggered in a system, article, apparatus, and/or method described herein by a visit of the patent to the hospital department, such as the ED. In one or more embodiments, the value associated with each resource is triggered in a processing stage. In one or more embodiments, a record may be generated based on each value associated with each resource that is triggered in a processing stage.

For example, referring to FIG. 60, a first value is provided when a patient is triaged. And, because the value associated with this resource is one, only one value is provided for this resource. A second value is provided when a patient is moved to a room. And, because the value associated with this resource is one, only one value is provided for this resource. A third value is provided when a patient requires another means of arrival (e.g., other than the patient). And, in one or more embodiments, when the value associated with this resource is two, either a value of two is always imposed, or one of two different values may be provided for this resource (in which, in some embodiments, the higher value is always imposed, and/or one of the two values may be imposed). A fourth value is provided when a patient requires specialized communication/language resources (e.g., interpreter, and/or one or more facilitators/tools for hearing impairment, and/or language impairment). And, because the value associated with this resource is two, either a value of two is always imposed, or one of two different values may be provided for this resource (in which, in some embodiments, the higher value is always imposed, and/or one of the two values may be imposed). A fifth value is provided when a patient requires documentation of valuables and/or securing them in a hospital safe. And, in one or more embodiments, when the value associated with this resource is two, either a value of two is always imposed, or one of two different values may be provided for this resource (in which, in some embodiments, the higher value is always imposed, and/or one of the two values may be imposed).

As such, in one or more embodiments, a value for one or more resources may be imposed from a plurality of values. In some embodiments, the value imposed may vary based on the resource (e.g., type of resource, quantity of resource, quality of resource and/or cost of the resource). In one or more embodiments when a value is varied, the imposed value is the greater value. For example, referring to FIG. 60, in one or more embodiments, the value imposed for means of arrival may be one, or the value may be two. In one example, one is imposed when no additional resources were required, and two is imposed when basic life support and/or advanced life support were utilized for arrival by, for example, an emergency medical service (EMS) provider (e.g., ambulance, helicopter). In another example, a value imposed for the communication/language resource may be one, or the value imposed may be two. One may be imposed when some help in language was required, and two may be imposed when an interpreter must be paged, and/or one or more devices must be utilized.

The resource value calculator may include at least one processor or controller configured to execute all or at least a portion of the at least one computer readable program code of the resource value calculator. The methods described herein may be performed by the at least one processor and/or controller, some of which are associated with one or more computing devices. The one or more computing devices and associated methods (provided via one or more computer readable program codes on one or more non-transitory computer readable mediums) may be further integrated with and, preferably, are in communication with one or more databases. The one or more computing device and/or the one or more databases may be associated with patient records. For each visit, the one or more computer readable program codes on one or more non-transitory computer readable mediums may be further integrated with the patient record (e.g., electronic health record or EHR). The one or more computing device, when integrated as described herein, will allow the resource value calculator to operate in the manners described herein, such as with and/or utilizing all or at least a part of the EHR of the patient.

The one or more computing devices and/or the controller may display the resources at a local workstation or terminal. The resource may correlate, correspond with, and/or include a temporal value, such as day and/or time. The resource may correlate, correspond with and/or include a quantity. The resource may correlate, correspond with and/or include a quality. The resource may correlate, correspond with and/or include a type. The resource may correlate, correspond with and/or include a cost.

The one or more computing devices and/or the controller may be configured to determine the value based on the resource selected.

The one or more computing devices and/or the controller may be configured to impose the value based on the resource selected.

The one or more computing devices and/or the controller may be configured to generate the adjustment based on one or a plurality of values determined for the visit of the patient.

The one or more computing devices and/or the controller may be configured to generate the adjustment based on one or a plurality of values imposed for the visit of the patient.

The one or more computing devices and/or the controller may be configured to determine the level of service based on the adjustment generated for the visit of the patient.

The one or more computing devices and/or the controller may be configured to transmit the level of service, such as to another computing device.

In one or more embodiments, a rule may be included and/or applied to impose at least one value. In one or more embodiments, the value may be a fixed value. In either case, the value that is imposed may be based on the quality of the resource, the quantity of the resource. In addition, or as an alternative, a value imposed for a resource may be based on personnel, expertise, and/or time utilized with the resource. In one or more embodiments, a rule may be utilized to include such factors, which may be applied to all the resources as a group or on resources associated with a category. In one or more embodiments, a resource utilizing more personnel and/or more expertise and/or more time will impose a higher value (than a resource that does not require such elements). In one or more embodiments, a resource utilizing expensive equipment (e.g., labor/delivery room or equipment, MRI/CT/US/NM, transfer vehicle, stroke and/or STEMI equipment) will impose a higher value (than a resource that does not require such elements). In one or more embodiments, a resource utilizing one or more medical devices and/or medicaments not of a generic or usual variety (e.g., for stroke, STEMI, delivery of a baby, gastric lavage) will impose a higher value (than a resource that does not require such elements). In one or more embodiments, a resource utilizing additional medical personnel not directly associated with an initial patient visit and/or with a medical specialist (e.g., physician, medical examiner, obstetrician, MRI/CT/US/NM technician) will impose a higher value (than a resource that does not require such elements).

As an example, for resources associated with intake in the ED (see, e.g., TABLE 1), a value for means of arrival (other than ambulatory) will impose a higher value than normal operations associated with intake (e.g., triage, room in ED, language/communication, valuable/documentation) because non-ambulatory means of arrival will require additional medical-type personnel and/or equipment.

As another example, for resources associated with diagnostics in the ED (see, e.g., TABLE 2), lab and radiology will impose a higher value than normal operations associated with diagnostics (e.g., EKG, specimen collection) because lab and radiology will require additional medical-type personnel and/or equipment. In addition, MRI/CT/US/NM will impose a higher value than lab and radiology because better trained medical-type personnel and more costly equipment will be utilized.

As another example, for resources associated with medication administration alone in the ED (see, e.g., TABLE 3), such administration will impose a same or similar value because the same personnel will be utilized in procedures that don't require an additional level of expertise for administration (other than the expertise already held by the medical-type personnel who is administering the medication).

As another example, for resources associated with interventions in the ED (see, e.g., TABLES 4A and 4B), certain interventions will impose a greater value because more qualified personnel (e.g., having a higher level of expertise) and/or more equipment and more time is associated with certain interventions. For example, a highest value will be imposed for gastric lavage. A lowest value will be imposed for oxygen.

As described herein, the one or more computing devices and/or the controller (including but not limited to the one or more apparatus and articles described herein) may integrate and/or coordinate with an EHR, such that data may be input and/or received in an EHR, in which the resource value calculator described herein is provided with and/or associated with the EHR. Data may include a request as described herein (e.g., for one or more resources), and/or further details about the patient, and/or details about the patient visit.

In one or more embodiments, data may be stored and/or captured and/or transmitted in and/or between one or more modules, such as a storage module, a recording module, and a resource value calculator module, in addition to one or more operating modules.

The one or more computing devices and associated modules, when integrated with and/or accessible, will allow for at least visualization of the EHR, manipulation of the EHR, capture of data associated with the EHR and/or the resource value calculator, storage of data associated with the EHR and/or the resource value calculator, and transfer or transmittal of data associated with the EHR and/or the resource value calculator. It is understood in the relevant field that other software may be used with the one or more systems, apparatuses, articles, and methods described herein.

Any apparatus and/or article (e.g., computing device and/or associated computer readable program code) provided as described herein will provide at least digital data, which may be stored, and/or analyzed and/or captured and/or transmitted, utilizing binary data, digital images, digital video, tables, charts, etc. Any of the data may be stored in a storage device, which may or may not be the same storage device storing the computer readable program code described herein, and may or may not be the same storage device storing information and/or data about a patient. Any of the data described herein may be processed and/or accessed by one or more suitable computing devices, such as the type having a central processing unit comprising logic, control circuitry, and memory (e.g., as volatile memory, cache memory) in addition to a storage space or memory (e.g., as non-volatile memory). The computing device may be any form (e.g., desktop computer form, portable computing form, smartphone, personal computer, laptop, electronic tablet device, global positioning system (GPS) receiver, portable media player, personal digital assistant (PDAs), and/or network access device), including any processing device capable of receiving and transmitting data. The computing device will require or will be coupled to a screen for visualization. The screen may be a touch screen. The same computing device, or a separate computing device may be utilized to process and/or analyze and/or communicate the data. Similarly, the same computing device or a separate device may be used to store the data, stored on the computer (machine) readable medium, in computer (machine) readable form. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or certain RAM. Transmission media may include coaxial cables, copper wire, fiber optic lines, and wires arranged in a bus. Transmission media may also take the form of electromagnetic, radio frequency, acoustic, or light waves, such as those generated during data communications, such as radio wave, and/or infrared data communications.

The computing device described herein associated with the resource value calculator will include at least one processor, and may or may not include a telephonic portion (and associated radios/receivers), and will include or be associated with a display, and will further include a means for accessing some or all of the data (e.g., keyboard, and/or touch screen). A user should be able to interface with at least one of the computing devices associated with the resource value calculator. Suitable computer operating systems software for the computing device, in addition to the resource value calculator may be from a Microsoft WINDOWS® family from Microsoft Corporation (e.g., Windows 95, 98, Me, Windows NT, Windows 2000, Windows XP, Windows XP x64 Edition, Windows Vista, Windows 7, Windows 8, Windows CE, Windows Mobile, Windows RT), or from any one of Symbian OS, Tizen, Linux, HP-UX, UNIX, Sun OS, Solaris, Mac OS X, Apple iOS, Android, Alpha OS, AIX, IRIX32, or IRIX64, as non-limiting examples.

All or a portion of the resource value calculator (e.g., a binary, machine-executable version) may be stored on at least one of the computing device in memory (e.g., RAM and/or cache memory), and/or may be stored on one or more alternative storage units (e.g., hard disk, magnetic disk, tape, or CD-ROM, one or more servers) and accessible by the computing device. As a further example, the code for the resource value calculator may be accessible and/or transmitted via wires, radio waves, cloud computing, and/or through a network such as the Internet. In another example, in operation, a system described herein may include one or more computer devices used to execute the resource value calculator accessible by and/or associated with the one or more computing devices, which will be involved in implementing one or more of the embodiments and/or steps of the embodiments described herein. The system may further include subsystems such as: one or more central processors, system memory (volatile and/or nonvolatile), input/output (I/O) controller, display adapter, serial or universal serial bus (USB) port, one or more network interfaces, one or more servers, firewall, and/or speaker. Additional or fewer subsystems may be included. The system may be a multiprocessor system. The processor of the computing device may comprise and/or be associated with multiple processors, or a multicore processor, which may permit parallel processing of information described herein. Other configurations of subsystems suitable for use with the embodiments described herein will be readily apparent to one of ordinary skill in the art.

In one or more embodiments, the resource value calculator may be accessible and/or connected to a network. The resource value calculator may interface with other computing devices using the network, including one or more computing devices that capture at least some of the data associated with the patient. The resource value calculator may also interface with other computing devices using the network, such as ones that involve auditing and/or billing associated with the visit of the patient to the hospital. The network may be an intranet, internet, or the Internet, as examples. The network may be an internal network only accessible to users associated with the hospital and/or users authorized by the hospital. The network may be a wired network, telephone network, packet network, and/or optical network (e.g., using optical fiber). In addition, or as an alternative, the network may be a wireless network. As an example, the network may be a wireless network using a protocol such as Wi-Fi (under IEEE standard, e.g., 802.11, 802.11a, 802.11b, 802.11e, 802.11g, 802.11i, 802.11n, 802.11ac, and 802.11ad), and/or a near field communication (NFC), and/or a radio-frequency identification (RFID), and/or a mobile and/or cellular wireless communication (e.g., 2G, 3G, 4G, 3GPP LTE, WiMAX, LTE, LTE Advanced, Flash-OFDM, HIPERMAN, iBurst, EDGE Evolution, UMTS, UMTS-TDD, 1×RDD, and EV-DO).

In at least one embodiment, the resource value calculator, and systems, apparatuses, articles and methods utilizing the resource value calculator, will be associated with at least one workstation operable with and executing an application associated with the resource value calculator, which may be a local application, or one accessible through the Internet, via a web browser. In one or more embodiments, the application may be one utilizing and/or providing EHR for patients in a hospital setting. A representative example is an application provided by Epic, such as CareConnect, which is an EHR-based application. The application and/or the web browser may provide a plurality of selectable pages and content thereon in suitable formats (e.g., HTML, XML, text, PDF, postscript, etc.). The application and/or the web browser allow data to be downloaded from the pages, and may be used to upload other data, which may be accessible to other parts of the system. The local application may be on the hard drive or a disk, as examples. In some embodiments, the local application may be updated (e.g., periodically or on demand) via a direct internet upgrade linking mechanism, or through an applications storehouse (e.g., Apple iTunes and App store, Google Play store, Windows Phone App store, etc.). In some embodiments, the application may be associated with a cloud infrastructure, relying on a virtual desktop, and having accessible software stored remotely on one or more remote storage units. The cloud infrastructure may comprise any of a number of suitable platforms (e.g., software as a service (SaaS), platform as a service (PaaS), infrastructure as a service (IaaS), combinations, and/or improvements thereof. Examples of cloud computing services are Google Drive, Apple iCloud, Microsoft OneDrive, Microsoft Office Online, Amazon Cloud Drive, that may be adapted to a system described herein.

One or more servers may be associated with the one or more computing devices that are associated with the resource value calculator. The one or more servers may include a client system operably coupled with and/or in communication with a network (e.g., via an access provider, and/or a server system). The client system(s) typically request information from the server system, which provides the information. In some embodiments, a computer system may act as both a client system and a server system depending on whether the computer system is requesting or providing information, and/or may act as a stand-alone computer system.

In a system described herein, the system may comprise at least a value database, a resource database, a rules library, a processor, and memory. Such a system or one or more components thereof may be integrated with, and/or accessible in, and/or associated with an EHR. A computing device of the type known in the art and/or as described herein (and/or a server) may be utilized with the system. The computing device and/or server will include at least a processor for controlling overall operation and associated components, one or more memory (generally in the form of RAM and ROM, or a variation thereof, and a separate memory), an input/output module. The computing device and/or server may include or communicate with one or more receiver modules, server modules and processors that may be configured to received requests, apply certain rules regarding said requests, impose a value with one or more of the received requests, generate an adjustment, and establish one or more correlations with one or more requests, and/or perform other suitable actions or tasks related to providing and/or identifying the level of service as described herein. At least some of the memory will store software and/or computer code used by the computing device and to provide instructions to the processor to enable the computing device to perform one or more functions. As one example, at least one memory may store software for one or more applications programs, associated databases, and/or the operating system. In addition, or as an alternative, some or all of the computer executable instructions of the computing device and/or server may be embodied in hardware or firmware. One or more databases may be utilized for storage of EHR, the plurality of resources, the plurality of categories associated with some of the plurality of resources, the values imposed for at least some of the plurality of resources, rules for imposing one or more values, patient information, and other metrics or attributes as described herein. Any information in connection with the one or more databases may be stored in the memory of the computing device and/or server, or may be stored separately, but is accessible by the computing device and/or server. The computing device may operate in a networked environment supporting connections to one or more computing devices or computers, some of which may be provided in one or more workstations, some of which may be remote.

Any system as described herein may further comprise a transaction record database that stores one or more records of transactions. Any system may further comprise a request database that stores one or more records of requests. Each stored request, such as for a resource, may include one or more values. A processor may search the record database for the value, or may search for a rule associated with the resource and/or the value. Based on the value, and/or the rule, the processor may impose the value associated with the request for the resource, when the resource correlated with at least one value. A rules library may include one or more rules for determining the value imposed for a request for one or more resources, and/or which request will impose a value (or values). The rules may also include rules for other transactions, and for generating an adjustment. The rules may include information that shows when a certain resource may impose a value, and/or when a certain value may be imposed for a certain resource. The rules may include one or more performance metrics. The rules will include formulating an adjustment in a calculation, which will be based on the values imposed, and/or any other rules therein. The adjustment is thereafter transmitted, which may be to one or more computing device in the system. The level of service may be automatically transmitted for billing purposes. In some embodiments, the adjustment may be modified, but this is typically performed during an auditing step, and/or after review of certain data, which may or may not include one or more manual operations, and/or may involve additional input.

Methods associated with any of the above-referenced embodiments may involve and/or may utilize any suitable elements, steps, computer-executable instructions, or computer-readable data structures. As such, other embodiments are disclosed herein as well that can be partially or wholly implemented on a computer-readable medium, for example, by storing computer-executable instructions or modules or by utilizing computer-readable data structures.

As used herein and in the appended claims, the singular forms “a,” “and,” and “the” include plural referents unless the context clearly dictates otherwise. Thus, for example, reference to “an agent” or to “a composition” includes a plurality of such agents or compositions, and equivalents thereof known to those skilled in the art, and so forth. It is understood that “comprising” (and related terms such as “comprise” or “comprises” or “having” or “including”) is not intended to exclude embodiments wherein, for example, any composition of matter, composition, method, or process, or the like, described herein may “consist of” or “consist essentially of” the described features. Although representative processes and articles have been described in detail herein, those skilled in the art will recognize that various substitutions and modifications may be made without departing from the scope and spirit of what is described and defined by the appended claims.

1. A departmental management system for a health care department at a hospital, the departmental management system comprising:
a computer system including at least one computer,
at least one storage medium, accessible by the at least one computer, in which is stored at least all or a portion of a resource value calculator for generating an integer associated with care of a person by the health care department of the hospital in relation to a visit by the person to the health care department of the hospital,
a request component within or in communication with the at least one computer, and
a computer readable medium storing computer code which when executed by the computer system causes the computer system to perform operations including: receive one or more requests associated with the care of the person by the health care department in relation to the visit of the person to the health care department; impose a value for each request based at least on information stored in the at least one storage medium; and provide the integer based on the value imposed for each of the one or more requests, the integer determined in a calculation operation.

2. The system of claim 1, wherein the computer code comprises code which when executed by the computer system causes the computer system to impose the value.

3. The system of claim 1, wherein the computer code comprises code which when executed by the computer system causes the computer system to generate the integer.

4. The system of claim 1, wherein the integer is associated with a level of service associated with the care of the person by the health care department in relation to the visit of the person to the health care department.

5. The system of claim 1, wherein the at least one storage medium stores or accesses at least a portion of health-related information of the person.

6. The system of claim 1, wherein the resource value calculator is integrated with at least a portion of an electronic health record of the person.

7. The system of claim 1, wherein the at least one storage medium includes or accesses one or more databases, the one or more databases storing the value to be imposed for each request.

8. The system of claim 1, wherein the value to be imposed for each request is associated with one or more departmental resources utilized in the request.

9. The system of claim 1, wherein the value to be imposed for each request is associated with one or more departmental resources utilized in the request.

10. The system of claim 1, wherein the value to be imposed for each request is associated with one or more departmental resources associated with the request, and the value is a numeric value less than 10 when the one or more resources are non-critical care.

11. The system of claim 1, wherein the value to be imposed for each request is associated with one or more departmental resources utilized with the request, and the value is a numeric value less than 10 when the one or more resources are non-critical care.

12. A method of management for a health care department of a hospital using a computer system including at least one computer, at least one storage medium, accessible by the at least one computer, in which is stored all or at least a portion of a resource value calculator, and a request component within or in communication with the at least one computer, the method comprising:
receiving, by the computer system, one or more requests associated with a visit by the person to the health care department of the hospital;
imposing a value for at least some of the requests based on one or more resources associated with the at least some of the requests, in which for at least some of the requests the value imposed is associated with the one or more resources associated with the request, the value being stored in the at least one storage medium accessible by the at least one computer; and
providing an integer based on the value imposed for the at least some of the requests, the integer being determined in a calculation operation.

13. The method of claim 12, comprising, generating, by the computer system, a level of service for the visit by the person to the health care department of the hospital.

14. The method of claim 12, comprising, generating, by the computer system, a level of service for the visit by the person to the health care department of the hospital, the level of service being stored in at least one database.

15. The method of claim 12, where the method further comprises transmitting the level of service.

16. A non-transitory computer readable storage medium in which is stored computer code that causes a computer system to perform a method, the computer system comprising at least one computer, at least one storage medium, accessible by the at least one computer, in which is stored a value resource calculator, the computer code to perform the method, the method comprising:
receiving, by the computer system, one or more requests associated with a visit by the person to the health care department of the hospital;
imposing a value for at least some of the requests based on one or more resources associated with the at least some of the requests, in which for at least some of the requests the value imposed is associated with the one or more resources associated with the request, the value being stored in the at least one storage medium accessible by the at least one computer; and
providing an integer based on the value imposed for the at least some of the requests, the integer being determined in a calculation operation.

17. The non-transitory computer readable storage medium of claim 15, wherein the method comprises, generating, by the computer system, a level of service for the visit.

18. The non-transitory computer readable storage medium of claim 15, wherein the method comprises, generating, by the computer system, a level of service for the visit stored in the at least one storage medium.

19. A management system for a health care department of a hospital, the system comprising:
at least one controller that controls transmission of a plurality of requests, each request for at least one resource associated with a visit of a person at the health care department, captured by at least one computing device at the health care department of a hospital;
a processing system that determines authorization for the plurality of requests or determines authorization to access the at least one computing device;
a value engine that interfaces between the at least one controller and the processing system, wherein the at least one controller receives the plurality of requests captured by the at least one computing device, and the value engine is configured to access at least some of the plurality of requests, or to intercept at least some of the plurality of requests before the plurality of requests are received by another processing system, wherein the value engine in response to accessing or intercepting the plurality of requests performs a computer implemented method of imposing a value associated with the plurality of requests, the method comprising:
accessing or intercepting at least some of the plurality of requests by the at least one controller;
determining a value associated with each request, which includes determining whether there is at least one value associated with each request, and imposing a value for each request that is determined to correlate with at least one value;
imposing the value that is associated with each request, or for each request that is determined to correlate at least one value, thereby imposing a plurality of values;
in a calculation operation, and in response to imposing the plurality of values, determining an integer associated with the plurality of values.

20. The management system of claim 20, wherein the method further comprising transmitting the integer to another computing device in the system to determine a level of service associated with the integer, the level of service identified from a relational table correlating each integer with one level of service, the level of service comprising Levels 1 to 5 and Critical Care.
